(19) United States
(12) Patent Application Publication
(10) Pub. No.: US 2012/0291750 A1
(43) Pub. Date: Nov. 22, 2012

(54) START CONTROL DEVICE FOR INTERNAL COMBUSTION ENGINE

(75) Inventors: Yuu Yokoyama, Okazaki-shi (JP); Masaki Numakura, Toyota-shi (JP)

(73) Assignee: TOYOTA JIDOSHA KABUSHIKI KAISHA, Toyota-shi, Aichi-ken (JP)

(21) Appl. No.: 13/382,048

(22) PCT Filed: Feb. 10, 2010
(86) PCT No.: PCT/JP2010/051970

§ 371 Date: Jan. 3, 2012

(51) Int. Cl. F02D 13/02

(52) U.S. Cl. 123/347

(57) ABSTRACT

A start control device for an internal combustion engine controls a starting manner of the engine having a hydraulic variable mechanism, which fixes valve timing at a middle angle. Specifically, with the engine speed during cranking when the valve timing is not fixed at the middle angle defined as a first engine speed and the engine speed during cranking when the valve timing is fixed at the middle angle defined as a second engine speed, the start control device performs starting control for decreasing the first engine speed compared to the second engine speed during engine starting. As a result, the valve timing is fixed at the middle angle at increased frequency.

### TECHNICAL FIELD

The present invention relates to a start control device for controlling a starting mode in an internal combustion engine including a hydraulic variable valve mechanism, which varies valve timing and fixes the valve timing at a middle angle.

### BACKGROUND ART

As one such variable valve mechanism, a mechanism described in Patent Document 1, for example, is known.

A variable valve mechanism described in Patent Document 1 includes a housing rotor, a vane rotor, and a fixing mechanism. The housing rotor rotates synchronously with the crankshaft and the vane rotor rotates synchronously with the camshafts. The fixing mechanism causes engagement between the rotors and fixes valve timing of an intake valve to a middle angle. When the rotational phase of the vane rotor relative to the rotational phase of the housing rotor is a middle phase, the fixing mechanism causes a pin projecting from the vane rotor to be received in a hole of the housing rotor. The fixing mechanism thus restricts relative rotation of the housing rotor and the vane rotor.

When an internal combustion engine having the variable valve mechanism starts, torque produced by each camshaft is changed through engine starting and rotates the vane rotor in an advancing direction relative to the housing rotor. This fixes the valve timing at the middle angle when the engine is started, without controlling the variable valve mechanism through hydraulic pressure.

### PRIOR ART DOCUMENT

### Patent Document

Patent Document 1: Japanese Laid-Open Patent Publication No. 2002-122009

### SUMMARY OF THE INVENTION

### Problems that the Invention is to Solve

However, if the amount of rotation of the vane rotor relative to the housing rotor caused by the torque change per cycle of camshaft rotation is small, the vane rotor does not reach the middle phase. As a result, the relative rotation of the housing rotor and the vane rotor is not restricted by the fixing mechanism. In this case, the engine is started with the valve timing maintained at an angle retarded with respect to the middle angle. Engine starting is thus hampered.

Accordingly, it is an objective of the present invention to provide an engine start control device for an internal combustion engine capable of fixing valve timing at a middle angle at high frequency when the engine is started.

### Means for Solving the Problems

Means for achieving the aforementioned objective and advantages of the present invention will now be described.

Hereinafter, engine starting will be referred to as released starting if initiated without fixing the valve timing at the middle angle and fixed starting when performed with the valve timing fixed.

The present invention provides a start control device for controlling a starting manner in an internal combustion engine having a hydraulic variable valve mechanism that varies valve timing and fixes the valve timing at a middle angle. With the engine speed during cranking when the valve timing is not fixed at the middle angle defined as a first engine speed and the engine speed during cranking when the valve timing is fixed at the middle angle defined as a second engine speed, the start control device performs speed reduction control to decrease the first engine speed compared to the second engine speed during engine starting.

When the length of one torque change cycle of a camshaft and the peak value in the cycle are compared between a state A with a relatively low engine speed and a state B with a relatively high engine speed, the length of the torque change cycle and the peak value in the cycle are greater in the state A than in the state B.

In the above-described invention, the engine speed in released starting (the first engine speed) is smaller than the engine speed in fixed starting (the second engine speed). This increases the length of one torque change cycle and the peak value in the cycle in the released starting compared to the fixed starting. The valve timing thus easily reaches the middle angle in the released starting. As a result, the valve timing is fixed at the middle angle with increased frequency during engine starting.

One aspect of the present invention, the engine includes a motor that applies torque to a crankshaft. With the torque applied from the motor to the crankshaft when the valve timing is not fixed at the middle angle defined as a first torque and the torque applied from the motor to the crankshaft when the valve timing is fixed at the middle angle defined as a second torque, the speed reduction control decreases the first torque compared to the second torque during engine starting.

In the above-described aspect of the invention, torque applied to the crankshaft in released starting (first torque) is smaller than torque applied to the crankshaft in fixed starting (second torque). This decreases the engine speed in the released starting compared to the fixed starting, thus increasing the length of one torque change cycle and the peak value in the cycle in the released starting compared to the fixed starting.

One aspect of the present invention, the engine includes a motor that applies torque to a crankshaft. With load of the motor when the valve timing is not fixed at the middle angle defined as a first motor load and load of the motor when the valve timing is fixed at the middle angle defined as a second motor load, the speed reduction control increases the first motor load compared to the second motor load during engine starting.

In the above-described aspect of the invention, the motor load in released starting (first motor load) is greater than the motor load in fixed starting (second motor load).

This decreases the engine speed in the released starting compared to the fixed starting. As a result, the length of one torque change cycle and the peak value in the cycle are greater in the released starting than in the fixed starting.

One aspect of the present invention, the start control device performs the speed reduction control only when an engine temperature is lower than a predetermined temperature.

In engine starting, the state of combustion improves as the engine temperature rises. Accordingly, at a high engine temperature, starting of an internal combustion engine is unlikely to be hampered even if the valve timing is not fixed at the middle angle. In the above-described aspect of the invention, the speed reduction control is carried out only when the engine temperature is lower than the predetermined temperature. This quickly increases the engine temperature when hampering of the engine starting is unlikely to occur.

One aspect of the present invention, the start control device starts the speed reduction control after a predetermined time elapses from initiation of cranking.

In the above-described aspect of the invention, the speed reduction control is not performed until after the predetermined time period from initiation of cranking has passed. In other words, the speed reduction control is prevented from being carried out in the immediate period after initiation of engine starting in which great torque is necessary for cranking. This decreases the frequency at which the engine starting is hampered due to an insufficient motor torque.

One aspect of the present invention, the predetermined time corresponds to the period from when cranking is initiated to when an initial compression stroke is completed.

In the above-described aspect of the invention, the predetermined time is set to the time corresponding to the time from initiation of cranking to completion of an initial compression stroke, which is an engine starting period in which a particularly great torque is necessary for cranking. This decreases the frequency at which engine starting is hampered due to an insufficient motor torque.

One aspect of the present invention, when the voltage of a battery for supplying electric power to the motor is lower than a predetermined voltage, the start control device starts the speed reduction control after the predetermined time.

In the above-described aspect of the invention, when the voltage of a battery that supplies power to the motor is smaller than the predetermined voltage, the torque necessary for the motor in cranking is unlikely to be ensured, and the speed reduction control is started after the predetermined time period has passed. This decreases the frequency at which engine starting is hampered due to an insufficient motor torque.

One aspect of the present invention, the start control device ends the speed reduction control after a reference time elapses from initiation of the speed reduction control.

In the above-described aspect of the invention, the speed reduction control is ended after the reference time period from the start of the speed reduction control has elapsed, or after a sufficient time period for the valve timing to reach the middle angle from the initiation of the speed reduction control has elapsed. This prevents the speed reduction control from being continuously performed with the valve timing fixed at the middle angle.

One aspect of the present invention, the hydraulic variable valve mechanism is configured to change a valve timing of an intake valve. The hydraulic variable valve mechanism includes a restricting mechanism that restricts change of the valve timing in a retarding direction when the valve timing advances from an angle retarded with respect to the middle angle based on a cam torque change during engine starting.

In the above-described aspect of the invention, when the valve timing of the intake valve advances from an angle retarded with respect to the middle angle in engine starting, retardation of the valve timing is restricted by the restricting mechanism. This increases the frequency at which the valve timing reaches the middle angle.

Methods of restricting retardation of the valve timing by the restricting mechanism include those described below. Specifically, when the valve timing becomes advanced exceeding a predetermined angle between the middle angle and the maximum retarded angle, the restricting mechanism restricts retardation of the valve timing with respect to the predetermined angle. Alternatively, when the valve timing becomes advanced from an angle retarded with respect to the middle angle, the restricting mechanism restricts retardation of the valve timing with respect to a current valve timing.

One aspect of the present invention, the hydraulic variable valve mechanism is configured to change a valve timing of an exhaust valve. The hydraulic variable valve mechanism includes a restricting mechanism that restricts change of the valve timing in an advancing direction when the valve timing retards from an angle advanced with respect to the middle angle based on a cam torque change during engine starting.

In the above-described aspect of the invention, when the valve timing of the exhaust valve retards from an angle advanced with respect to the middle angle in engine starting, advancement of the valve timing is restricted by the restricting mechanism. This increases the frequency at which the valve timing reaches the middle angle.

Methods of restricting advancement of the valve timing by the restricting mechanism include the manners described below. Specifically, when the valve timing becomes retarded to a degree that exceeds a predetermined angle between the middle angle and the maximum advanced angle, the restricting mechanism restricts advancement of the valve timing with respect to the predetermined angle. Alternatively, when the valve timing becomes retarded from an angle advanced with respect to the middle angle, the restricting mechanism restricts advancement of the valve timing with respect to a current valve timing.

### BRIEF DESCRIPTION OF THE DRAWINGS

FIG. 1 is a schematic view showing an internal combustion engine having a variable valve device according to a first embodiment of the present invention;

FIG. 2 is a cross-sectional view showing a variable mechanism of the first embodiment;

FIG. 3 is a schematic view illustrating a hydraulic pressure system of the variable mechanism of the first embodiment;

FIG. 4 is a cross-sectional view showing the variable mechanism of the first embodiment, as taken along line 4-4 of FIG. 2;

FIG. 5 is a schematic view showing an engagement groove of a first restricting mechanism and an engagement groove of a second restricting mechanism and the vicinities of the engagement grooves in the variable mechanism of the first embodiment;

FIGS. 6(a) to 6(c) are schematic views each showing operation of a first restricting pin and operation of a second restricting pin at the time when the rotation phase of a vane rotor relative to a housing rotor changes from a retarded side toward a middle phase in the variable mechanism of the first embodiment;

FIGS. 7(a) and 7(b) are schematic views each showing operation of the first restricting pin and operation of the second restricting pin at the time when the rotation phase of the vane rotor relative to the housing rotor changes from the retarded side toward the middle phase in the variable mechanism of the first embodiment;

FIG. 8 is a flowchart representing the steps of a normal stop procedure performed by an electronic control unit of the first embodiment;

FIG. 9 is a flowchart representing the steps of an emergency stop procedure performed by the electronic control unit of the first embodiment;

FIG. 10 is a graph representing relationship between engine speed and torque change in an internal combustion engine;

FIG. 11 is a flowchart representing the steps of a start-time procedure performed by the electronic control unit of the first embodiment;

FIG. 12 is a schematic view illustrating a hydraulic pressure system according to a second embodiment of the present invention;

FIGS. 13(a) to 13(c) are tables each representing relationships between operating modes and supply/drainage states of lubricant oil for a variable mechanism of the second embodiment; and

FIG. 14 is a cross-sectional view showing a modified example of the variable mechanism of the second embodiment.

### MODES FOR CARRYING OUT THE INVENTION

### First Embodiment

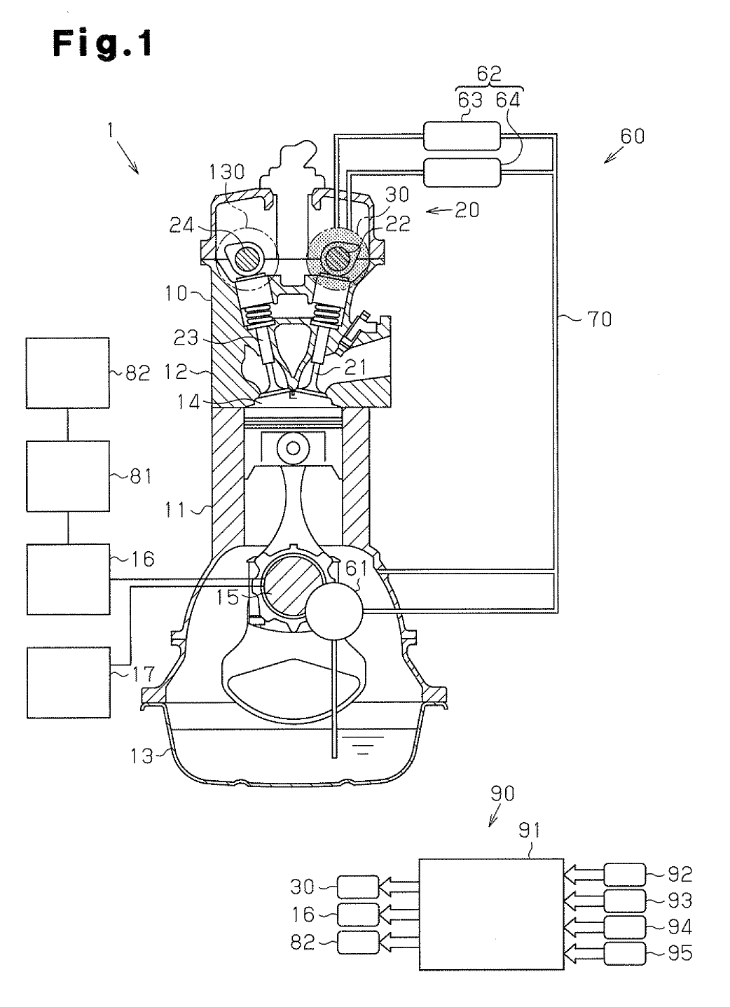

A first embodiment of the present invention will now be described with reference to FIGS. 1 to 11.

FIG. 1 shows a portion of a vehicle including an internal combustion engine 1.

The vehicle includes the engine 1, which drives wheels by power generated through combustion of air-fuel mixture, a battery 81 for storing electric power, various types of auxiliary electric devices 82, which are driven by the electric power from the battery 81, and a control device 90 for generally controlling these devices. The auxiliary electric devices 82 include a seat heater for heating seats in the passenger compartment and various lights in the passenger compartment and outside the vehicle.

The engine 1 includes a cylinder block 11 and an engine body 10, which has a cylinder head 12 and an oil pan 13, a variable valve device 20 including components of a valve drive system arranged in the cylinder head 12, a lubricating device 60 for supplying lubricant oil to the engine body 10 and the like, and various types of auxiliary devices. The auxiliary devices include a starter motor 16, which is actuated by the electric power supplied from the battery 81 and applies torque to a crankshaft 15, and an alternator 17, which is driven by power generated by the crankshaft 15.

The variable valve device 20 includes an intake valve 21 and an exhaust valve 23, which selectively opens and closes a combustion chamber 14, an intake camshaft 22 and an exhaust camshaft 24, which depresses the corresponding valves 21, 23, and a variable mechanism 30. The variable mechanism 30 changes the rotational phase of the intake camshaft 22 relative to the rotational phase of the crankshaft 15 (hereinafter, referred to as the intake valve timing VT).

The lubricating device 60 includes an oil pump 61, which sends lubricant oil from the oil pan 13, a lubricant oil passage 70 for supplying the lubricant oil from the oil pump 61 to various components of the engine 1, and a hydraulic pressure control device 62 for controlling the supply of lubricant oil for the variable mechanism 30.

The control device 90 includes various types of sensors and an electronic control unit 91, which carries out various types of calculating procedures for controlling the engine 1. The sensors include a crank position sensor 92, a cam position sensor 93, a coolant temperature sensor 94, and a voltage sensor 95.

The crank position sensor 92 outputs signals corresponding to the rotating angle of the crankshaft 15 (hereinafter, the crank angle CA) to the electronic control unit 91. The cam position sensor 93 provides signals corresponding to the rotating angle of the intake camshaft 22 (hereinafter, the intake cam angle DA) to the electronic control unit 91. The coolant temperature sensor 94 outputs signals corresponding to the temperature of coolant in the vicinity of a coolant outlet of the cylinder head 12 (hereinafter, the coolant temperature TW) to the electronic control unit 91. The voltage sensor 95 sends signals corresponding to voltage of the battery 81 (hereinafter, battery voltage BV) to the electronic control unit 91.

The electronic control unit 91 calculates parameters used for various controls, as will be described.

Specifically, the electronic control unit 91 obtains calculation values corresponding to the crank angle CA based on the output signals from the crank position sensor 92, calculation values corresponding to the rotating speed of the crankshaft 15 (hereinafter, the engine speed NE) based on the calculation values representing the crank angle CA, and calculation values corresponding to the cam angle DA based on the output signals from the cam position sensor 93. The electronic control unit 91 also determines calculation values corresponding to the valve timing VT based on the crank angle CA and the intake cam angle DA, calculation values corresponding to the intake valve timing VT based on the crank angle CA and the intake cam angle DA, and calculation values corresponding to the coolant temperature TW based on the output signals from the coolant temperature sensor 94. The electronic control unit 91 further obtains calculation values corresponding to the temperature of lubricant oil (hereinafter, the lubricant temperature TL) based on the coolant temperature TW and calculation values corresponding to the battery voltage BV based on the output signals from the voltage sensor 95.

Controls executed by the electronic control unit 91 include starting control for controlling the starter motor 16 when the engine 1 starts, operating-time valve timing control for changing the valve timing VT when the engine 1 operates, and stop-time valve timing control for changing the valve timing VT when the engine 1 stops. In the description below, stopping the engine 1 based on an engine stopping demand generated through manipulation of an ignition switch will be referred to as a normal stop. Stopping the engine 1 without an engine stopping demand will be referred to as an emergency stop.

In the starting control, cranking is carried out by the starter motor 16 based on a starting demand for the engine 1. The cranking by the starter motor 16 is ended when start of the engine 1 is completed.

In the operating-time valve timing control, the valve timing VT is switched between the maximum advanced valve timing (hereinafter, referred to as the maximum advanced angle VTmax) and the maximum retarded valve timing (the maximum retarded angle VTmin) based on an engine operating state. When there is a demand (hereinafter, a fixing demand) for fixing the valve timing VT at a specific timing (a middle angle VTmdl) between the maximum retarded angle VTmin and the maximum advanced angle VTmax, the valve timing VT is fixed at the middle angle VTmidl.

In the stop-time valve timing control, normal stop-time control for fixing the valve timing VT at the middle angle VTmdl at the time of a normal stop and emergency stop-time control for fixing the valve timing VT at the middle angle VTmdl at the time of an emergency stop are performed.

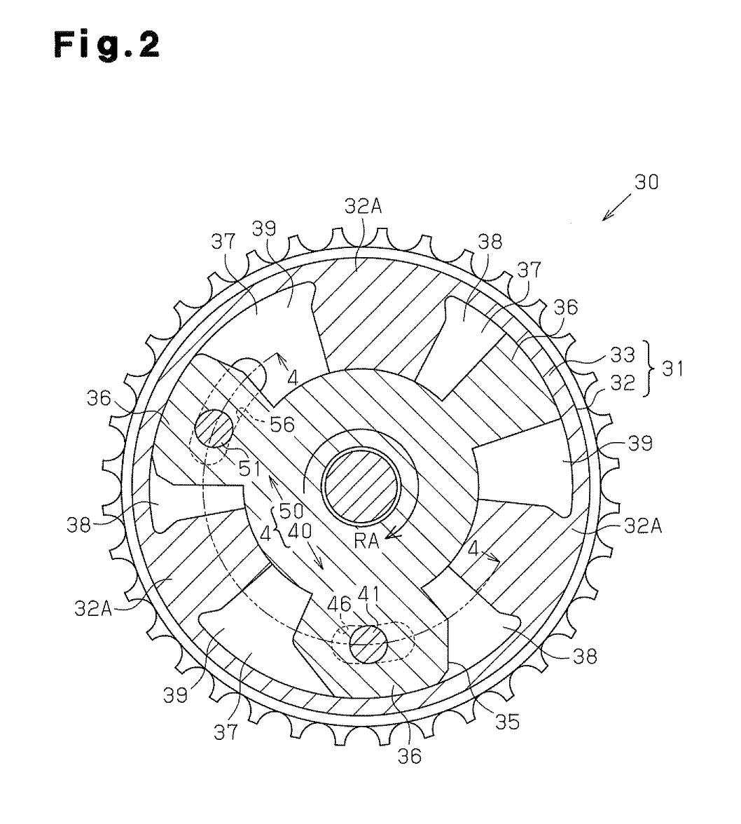

Referring to FIG. 2, the configuration of the variable mechanism 30 will hereafter be described.

The variable mechanism 30 includes a housing rotor 31, which rotates synchronously with the crankshaft 15, a vane rotor 35, which rotates synchronously with the intake camshaft 22, and a fixing mechanism 4 for fixing the valve timing VT at the middle angle VTmdl. The crankshaft 15 (a sprocket 33) and the intake camshaft 22 rotate in the direction indicated by arrow RA in FIG. 2.

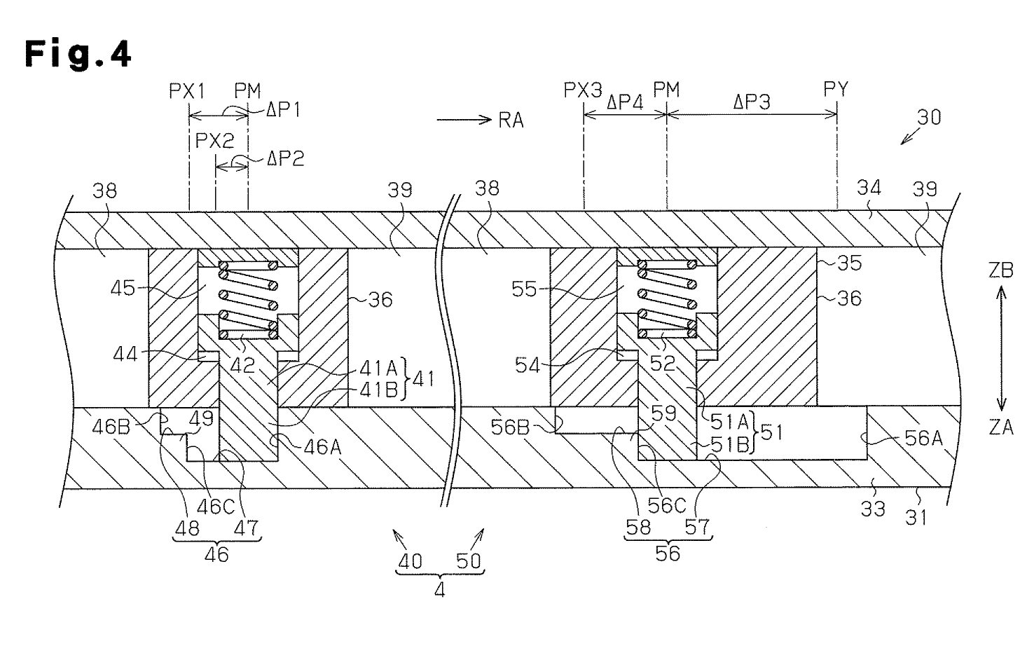

The housing rotor 31 has the sprocket 33, which is connected to the crankshaft 15 through a timing chain (not shown), a housing body 32, which is mounted at an inner side of the sprocket 33 and rotates integrally with the sprocket 33, and a cover 34 (see FIG. 4) attached to the housing body 32. The housing body 32 has three partition walls 32A, which project in radial directions of the rotary shaft of the housing rotor 31 (the intake camshaft 22).

The vane rotor 35 is fixed to an end of the intake camshaft 22 and arranged in the space in the housing body 32. The vane rotor 35 includes three vanes 36, each of which projects toward the gap between the corresponding adjacent pair of the partition walls 32A of the housing body 32. Each of the vanes 36 divides an accommodation chamber 37, which is formed between the corresponding adjacent pair of the partition walls 32A, into an advanced angle chamber 38 and a retarded angle chamber 39.

Each of the advanced angle chambers 38 is located rearward in the rotating direction RA of the intake camshaft 22 in the accommodation chamber 37 compared to the associated one of the vanes 36. Each of the retarded angle chambers 39 is located forward in the rotating direction RA of the intake camshaft 22 in the accommodation chamber 37 compared to the associated one of the vanes 36. The volume of each advanced angle chamber 38 and the volume of each retarded angle chamber 39 change in correspondence with a supply state of lubricant oil for the variable mechanism 30 brought about by the hydraulic pressure control device 62.

The variable mechanism 30 operates in the manner described below.

When lubricant oil is supplied to the advanced angle chambers 38 and drained from the retarded angle chambers 39 and the vane rotor 35 rotates to the advancing side, or in the rotating direction RA of the intake camshaft 22 relative to the housing rotor 31, the valve timing VT is changed to the advancing side. When the vane rotor 35 is rotated to the most advanced angle relative to the housing rotor 31, or when the rotation phase of the vane rotor 35 relative to the housing rotor 31 is the most forward in the rotating direction RA (hereinafter, the most advanced angle phase PH), the valve timing VT is set to the most advanced angle VTmax.

When lubricant oil is drained from the advanced angle chambers 38 and supplied to the retarded angle chambers 39 and the vane rotor 35 rotates to the retarding side, or in the opposite direction to the rotating direction RA of the intake camshaft 22 relative to the housing rotor 31, the valve timing VT is changed to the retarding side. When the vane rotor 35 is rotated to the most retarded angle relative to the housing rotor 31, or when the rotation phase of the vane rotor 35 relative to the housing rotor 31 is the most rearward in the rotating direction RA (hereinafter, the most retarded angle phase PL), the valve timing VT is set to the most retarded angle VTmin.

The fixing mechanism 4 includes a first restricting mechanism 40 for restricting change of the valve timing VT to the advancing side and a second restricting mechanism 50 for restricting change of the valve timing to the retarding side. The second restricting mechanism 50 is arranged at an advanced angle with respect to the first restricting mechanism 40. The first restricting mechanism 40 and the second restricting mechanism 50 cooperate to fix the rotation phase of the vane rotor 35 relative to the housing rotor 31 to the phase corresponding to the middle angle VTmdl (hereinafter, the middle phase PM). In other words, the valve timing VT is fixed at the middle angle VTmdl.

Hereinafter, operation to change the rotation phase of the vane rotor 35 relative to the housing rotor 31 toward the middle phase PM in order to fix the valve timing VT at the middle angle VTmdl will be referred to as fixing operation.

A valve timing VT suitable for starting the engine 1 is set as the middle angle VTmdl. In other words, starting performance is high in engine starting in a case in which the valve timing VT is set to the middle angle VTmdl compared to a case in which the valve timing VT is set to an angle retarded with respect to the middle angle VTmdl.

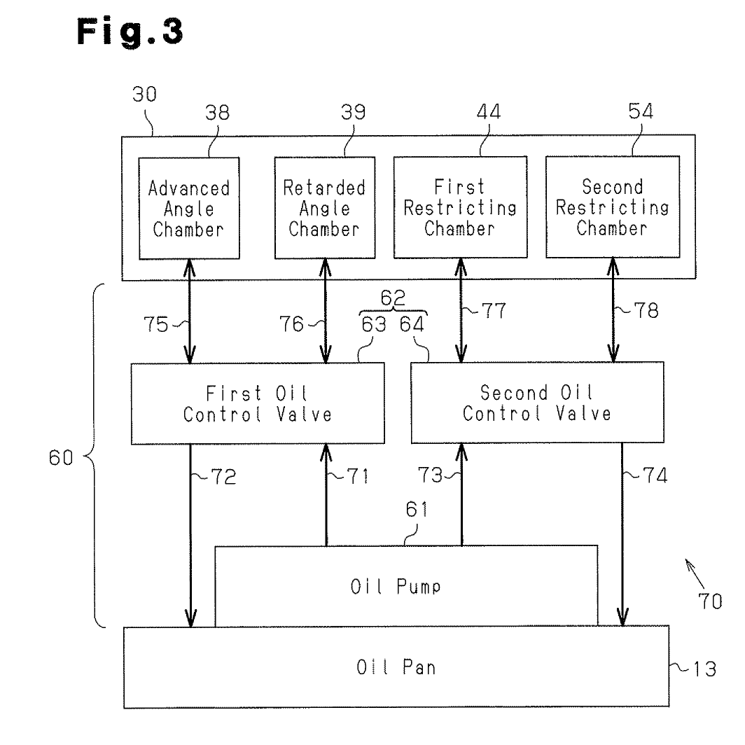

With reference to FIG. 3, a flow structure of lubricant oil between the lubricating device 60 and the variable mechanism 30 will be described. The diagram schematically represents the configuration of an oil passage between the lubricating device 60 and the variable mechanism 30.

The variable mechanism 30 has four types of hydraulic chambers, each having supply and drainage modes of lubricant oil that are switched by the hydraulic pressure control device 62. The four types of hydraulic chambers are the advanced angle chambers 38, the retarded angle chambers 39, a first restricting chamber 44, and a second restricting chamber 54.

After having been drained from the oil pump 61, lubricant oil is supplied to a first oil control valve 63 or a second oil control valve 64 through a first oil supply passage 71 or a second oil supply passage 73.

After having been supplied to the first oil control valve 63, the lubricant oil flows in the lubricant oil passage 70 in correspondence with an operating mode of the first oil control valve 63. The first oil control valve 63 operates in modes A1, A2, or A3.

(a) When the operating mode of the first oil control valve 63 is the mode A1, the first oil control valve 63 is in an operating state such that lubricant oil is supplied to the advanced angle chambers 38 and drained from the retarded angle chambers 39. In this state, the lubricant oil is supplied to each advanced angle chamber 38 through an advanced angle oil passage 75 and drained from each retarded angle chamber 39 through a retarded angle oil passage 76. The lubricant oil that has been drained from the retarded angle chambers 39 is returned to the oil pan 13 through the first oil control valve 63 and a first oil drainage passage 72.

(b) When the operating mode of the first oil control valve 63 is the mode A2, the first oil control valve 63 is in an operating state such that lubricant oil is supplied to the retarded angle chambers 39 and drained from the advanced angle chambers 38. In this state, the lubricant oil is supplied to each retarded angle chamber 39 through the retarded angle oil passage 76 and drained from each advanced angle chambers 38 through the advanced angle oil passage 75. The lubricant oil that has been drained from the advanced angle chambers 38 is returned to the oil pan 13 through the first oil control valve 63 and the first oil drainage passage 72.

(c) When the operating mode of the first oil control valve 63 is the mode A3, the first oil control valve 63 is in an operating state such that the lubricant oil in the advanced angle chambers 38 and the lubricant oil in the retarded angle chambers 39 are maintained. In this state, the lubricant oil flows neither between the advanced angle oil passage 75 and each advanced angle chamber 38 nor between the retarded angle oil passage 76 and each retarded angle chamber 39.

The lubricant oil that has been supplied to the second oil control valve 64 flows in the lubricant oil passage 70 in correspondence with an operating mode of the second oil control valve 64. The second oil control valve 64 operates in modes B1, B2, B3, or B4.

(a) When the operating mode of the second oil control valve 64 is the mode B1, the second oil control valve 64 is in an operating state such that lubricant oil is supplied to the first restricting chamber 44 and the second restricting chamber 54. In this state, the lubricant oil is supplied to the first restricting chamber 44 and the second restricting chamber 54 through the first restricting oil passage 77 and the second restricting oil passage 78.

(b) When the operating mode of the second oil control valve 64 is the mode B2, the second oil control valve 64 is in an operating state such that lubricant oil is drained from the first restricting chamber 44 and the second restricting chamber 54. In this state, the lubricant oil is drained from the first restricting chamber 44 and the second restricting chamber 54 through the first restricting oil passage 77 and the second restricting oil passage 78. The lubricant oil that has been drained from the restricting chambers 44, 54 is returned to the oil pan 13 through the second oil control valve 64 and the second oil drainage passage 74.

(c) When the operating mode of the second oil control valve 64 is the mode B3, the second oil control valve 64 is in an operating state such that lubricant oil is supplied to the first restricting chamber 44 and drained from the second restricting chamber 54. In this state, the lubricant oil is supplied to the first restricting chamber 44 through the first restricting oil passage 77 and drained from the second restricting chamber 54 through the second restricting oil passage 78. The lubricant oil that has been drained from the second restricting chamber 54 is returned to the oil pan 13 through the second oil control valve 64 and the second oil drainage passage 74.

(d) When the operating mode of the second oil control valve 64 is the mode 84, the second oil control valve 64 is in an operating state such that lubricant oil is drained from the first restricting chamber 44 and supplied to the second restricting chamber 54. In this state, the lubricant oil is drained from the first restricting chamber 44 through the first restricting oil passage 77 and supplied to the second restricting chamber 54 through the second restricting oil passage 78. The lubricant oil that has been drained from the first restricting chamber 44 is returned to the oil pan 13 through the second oil control valve 64 and the second oil drainage passage 74.

The configuration of the fixing mechanism 4 will now be described in detail with reference to FIG. 4. FIG. 4 is a plan view showing the cross section of the variable mechanism 30 taken along line 4-4 of FIG. 2.

The first restricting mechanism 40 includes a first restricting pin 41, a first engagement groove 46, and the first restricting chamber 44. The first restricting mechanism 40 also has a first restricting spring 42, which is arranged in the corresponding vane 36 and urges the first restricting pin 41 in one direction, and a first spring chamber 45 for accommodating the spring 42 in the vane 36.

The first restricting pin 41 is configured by a pin body portion 41A and a pin distal end portion 41B. When the distal surface of the first restricting pin 41 is pressed against the bottom surface of a first lower groove portion 47, the pin body portion 41A is received in the vane 36 and the pin distal end portion 41B is arranged in the first engagement groove 46. The pin body portion 41A and the pin distal end portion 41B are formed as coaxial cylindrical portions having equal diameters. When the hydraulic pressure in the first restricting chamber 44 is small compared to force produced by the first restricting spring 42, the first restricting pin 41 operates in such a direction as to project from the vane 36 (hereinafter, referred to as the projecting direction ZA). When the hydraulic pressure in the first restricting chamber 44 exceeds the force of the first restricting spring 42, the first restricting pin 41 operates in such a direction as to be received in the vane 36 (hereinafter, the accommodating direction ZB).

The first engagement groove 46 is configured by two groove portions having different depths, which are the first lower groove portion 47, which has a relatively great depth, and a first upper groove portion 48, which has a relatively small depth. A first stepped portion 49 is formed between the first lower groove portion 47 and the first upper groove portion 48 and defines the boundary between the groove portions.

The end of the first engagement groove 46 at the advancing side, which is the end of the first lower groove portion 47 at the advancing side (hereinafter, a first advanced angle end portion 46A), is arranged at the position corresponding to the middle phase PM. The end of the first engagement groove 46 at the retarding side, which is the end of the first upper groove portion 48 at the retarding side (hereinafter, a first retarded angle end portion 46B), is arranged at the position corresponding to the first retarded angle phase PX1, which is retarded with respect to the middle phase PM by a predetermined amount ΔP1. The first stepped portion 49 of the first engagement groove 46, which is the end of the first lower groove portion 47 at the retarding side (hereinafter, a first stepped end portion 46C), is arranged at the position corresponding to the second retarded angle phase PX2, which is retarded with respect to the middle phase PM by a predetermined amount ΔP2 (ΔP2<the predetermined amount ΔP1).

In the description below, the position of the first restricting pin 41 at the time when the pin distal end portion 41B is in the first lower groove portion 47 will be referred to as the lower engagement position of the first restricting pin 41. The position of the first restricting pin 41 at the time when the pin distal end portion 41B is outside the first lower groove portion 47 in the first engagement groove 46 will be referred to as the upper engagement position of the first restricting pin 41. The position of the first restricting pin 41 at the time when the pin distal end portion 41B is outside the first engagement groove 46 will be referred to as the released position of the first restricting pin 41.

The second restricting mechanism 50 includes a second restricting pin 51, a second engagement groove 56, and the second restricting chamber 54. The second restricting mechanism 50 also has a second restricting spring 52, which is arranged in the corresponding vane 36 and urges the second restricting pin 51 in one direction, and a second spring chamber 55, which accommodates the spring 52 in the vane 36.

The second restricting pin 51 is configured by a pin body portion 51A and a pin distal end portion 51B. When the distal surface of the second restricting pin 51 is pressed against the bottom surface of a second lower groove portion 57, the pin body portion 51A is received in the vane 36 and the pin distal end portion 51B is arranged outside the vane 36. The pin body portion 51A and the pin distal end portion 51B are formed as coaxial cylindrical portions having equal diameters. When the hydraulic pressure in the second restricting chamber 54 is small compared to force produced by the second restricting spring 52, the second restricting pin 51 operates in a direction to project from the vane 36, which is the projecting direction ZA. When the hydraulic pressure in the second restricting chamber 54 exceeds the force of the second restricting spring 52, the second restricting pin 51 operates in a direction to be received in the vane 36, which is the accommodating direction ZB.

The second engagement groove 56 is configured by two groove portions having different depths, which are the second lower groove portion 57 having a relatively great depth and a second upper groove portion 58 having a relatively small depth. A second stepped portion 59 is formed between the second lower groove portion 57 and the second upper groove portion 58 and defines the boundary between the groove portions.

The end of the second engagement groove 56 at the advancing side, which is the end of the second lower groove portion 57 at the advancing side (hereinafter, a second advanced angle end portion 56A), is arranged at the position corresponding an advanced angle phase PY, which is advanced with respect to the middle phase PM by a predetermined amount ΔP3 (ΔP3>the predetermined amount ΔP1>the predetermined amount ΔP2). The end of the second engagement groove 56 at the retarding side, which is the end of the second upper groove portion 58 at the retarding side (hereinafter, a second retarded angle end portion 56B), is arranged at the position corresponding to the third retarded angle phase PX3, which is retarded with respect to the middle phase PM by a predetermined amount ΔP4. The second stepped portion 59 of the second engagement groove 56, which is the end of the second lower groove portion 57 at the retarding side (hereinafter, a second stepped end portion 56C), is arranged at the position corresponding to the middle phase PM.

In the description below, the position of the second restricting pin 51 at the time when the pin distal end portion 51B is in the second lower groove portion 57 will be referred to as the lower engagement position of the second restricting pin 51. The position of the second restricting pin 51 at the time when the pin distal end portion 51B is outside the second lower groove portion 57 in the second engagement groove 56 will be referred to as the upper engagement position of the second restricting pin 51. The position of the second restricting pin 51 at the time when the pin distal end portion 51B is outside the second engagement groove 56 will be referred to as the released position of the second restricting pin 51.

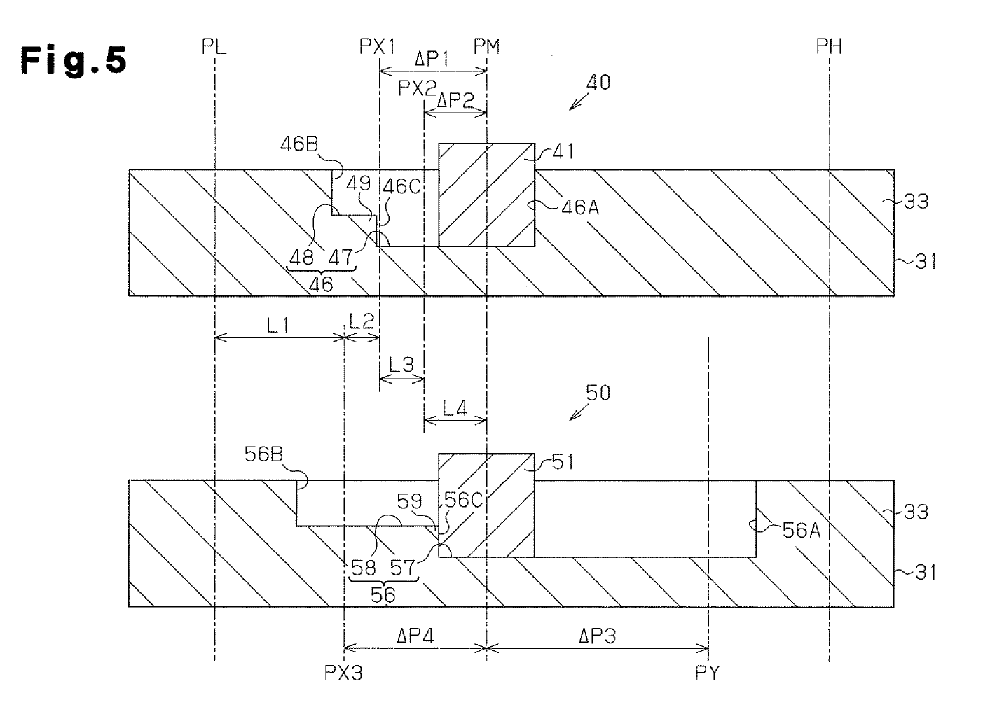

With reference to FIG. 5, the relationship between the length of the first engagement groove 46 and the length of the second engagement groove 56 will now be described. In the drawing, the first and second restricting mechanisms 40, 50 are illustrated as arranged in an up-and-down direction with the rotational phases of the vane rotor 35 and the housing rotor 31 coinciding. The single dashed lines in FIG. 5 represent the axis of the first restricting pin 41 and the axis of the second restricting pin 51.

The relationship among the predetermined amounts ΔP1, ΔP2 of the first engagement groove 46 and the predetermined amounts ΔP3, ΔP4 of the second engagement groove 56 is represented by the expression the predetermined amount ΔP4>the predetermined amount ΔP3>the predetermined amount ΔP1>the predetermined amount ΔP2.

The circumferential length from the maximum retarded angle phase PL to the third retarded angle phase PX3 is defined as the step width L1. The circumferential length from the third retarded angle phase PX3 to the first retarded angle phase PX1 is defined as the step width L2. The circumferential length from the first retarded angle phase PX1 to the second retarded angle phase PX2 is defined as the step width L3. The circumferential length from the second retarded angle phase PX2 to the middle phase PM is defined as the step width L4. The relationship among these step widths is represented by the expression the step width L1>the step width L4>the step width L3>the step width L2.

When the valve timing VT is changed from the maximum retarded angle VTmin to the middle angle VTmdl, the rotating amount of the vane rotor 35 relative to the housing rotor 31 is the sum of the step widths L1 to L4.

Operation of the fixing mechanism 4 will hereafter be described with reference to FIG. 4.

In the first restricting mechanism 40, when the pin distal end portion 41B of the first restricting pin 41 is accommodated in the vane rotor 35 and lubricant oil is supplied to the first restricting chamber 44, the first restricting pin 41 is received in the vane rotor 35.

When lubricant oil is drained from the first restricting chamber 44 with the pin distal end portion 41B of the first restricting pin 41 accommodated in the vane rotor 35, the first restricting pin 41 projects from the vane rotor 35. In this case, if the rotation phase of the vane rotor 35 relative to the housing rotor 31 is between the middle phase PM and the second retarded angle phase PX2, the pin distal end portion 41B is pressed against the bottom surface of the first lower groove portion 47. If the rotation phase of the vane rotor 35 relative to the housing rotor 31 is between the first retarded angle phase PX1 and the second retarded angle phase PX2, the pin distal end portion 41B is pressed against the bottom surface of the first upper groove portion 48.

In the second restricting mechanism 50, when the pin distal end portion 51B of the second restricting pin 51 projects from the vane rotor 35 and lubricant oil is sent to the second restricting chamber 54, the second restricting pin 51 is accommodated in the vane rotor 35.

When lubricant oil is drained from the second restricting chamber 54 with the pin distal end portion 51B of the second restricting pin 51 accommodated in the vane rotor 35, the second restricting pin 51 projects from the vane rotor 35. In this case, if the rotation phase of the vane rotor 35 relative to the housing rotor 31 is between the middle phase PM and the advanced angle phase PY, the pin distal end portion 51B is pressed against the bottom surface of the second lower groove portion 57. If the rotation phase of the vane rotor 35 relative to the housing rotor 31 is between the middle phase PM and the third retarded angle phase PX3, the pin distal end portion 51B is pressed against the bottom surface of the second upper groove portion 58.

The fixing mechanism 4 controls the valve timing VT as will be described.

When the first restricting pin 41 is arranged at the lower engagement position and the second restricting pin 51 is held at the released position, the rotation range of the vane rotor 35 relative to the housing rotor 31 is restricted to the range from the second advanced angle end portion 56A to the second stepped end portion 56C of the second lower groove portion 57. In other words, the rotation phase of the vane rotor 35 relative to the housing rotor 31 is restricted at the middle phase PM in rotation in the retarding direction and the advanced angle phase PY in rotation in the advancing direction.

When the first restricting pin 41 and the second restricting pin 51 are both at the lower engagement positions, rotation of the vane rotor 35 relative to the housing rotor 31 in the advancing direction is restricted by engagement between the first restricting pin 41 and the first lower groove portion 47. Rotation of the vane rotor 35 relative to the housing rotor 31 in the retarding direction is restricted by engagement between the second restricting pin 51 and the second lower groove portion 57. That is, the rotation of the vane rotor 35 relative to the housing rotor 31 is fixed at the middle phase PM. This fixes the valve timing VT at the middle angle VTmdl.

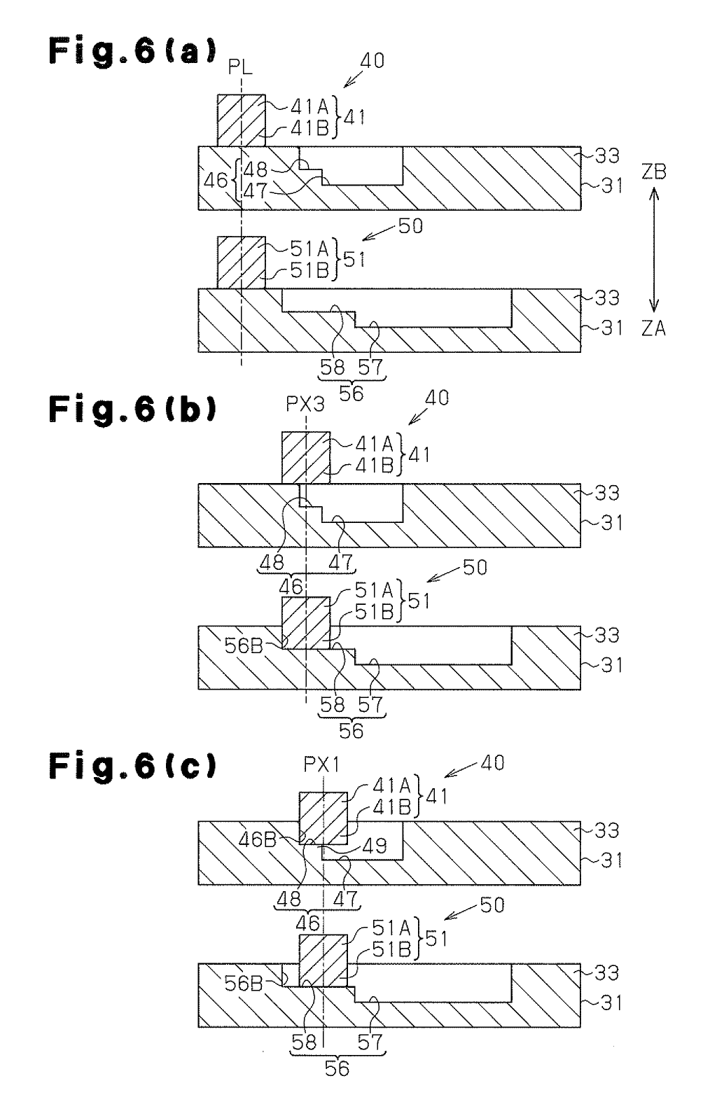

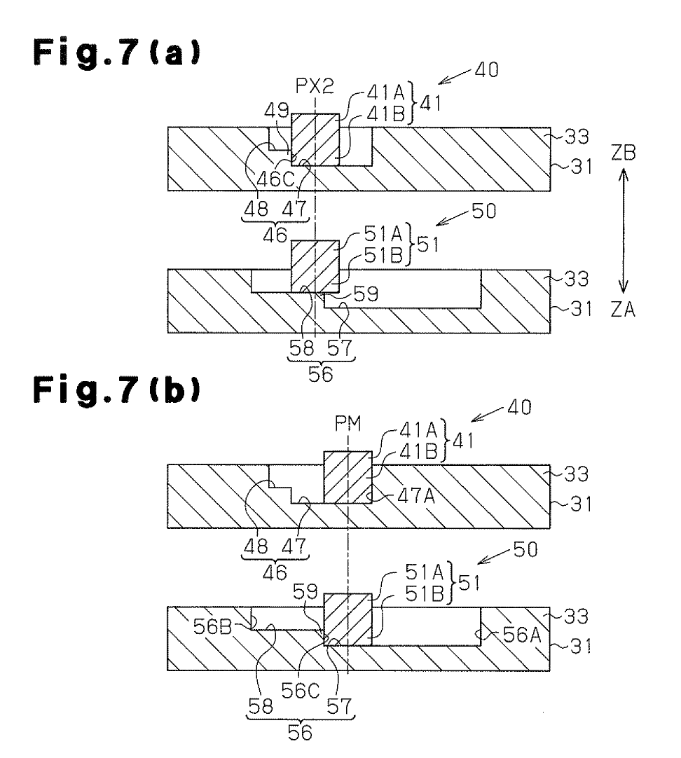

With reference to FIGS. 6 and 7, middle angle fixing by the fixing mechanism 4 on the premise that the valve timing VT is retarded with respect to the middle angle VTmdl will now be described. In the drawings, the first and second restricting mechanisms 40, 50 are illustrated as arranged in an up-and-down direction with the rotation phases of the vane rotor 35 and the housing rotor 31 coinciding with each other. The single dashed lines in the drawings represent the axis of the first restricting pin 41 and the axis of the second restricting pin 51.

When the electronic control unit 91 determines that a demand for fixing the valve timing VT at the middle angle VTmdl has been generated with the valve timing VT retarded with respect to the middle angle VTmdl, the electronic control unit 91 transmits command signals to the first oil control valve 63 and the second oil control valve 64. Specifically, the first oil control valve 63 receives a command signal for maintaining the operating state in which lubricant oil is supplied to each advanced angle chamber 38 and drained from each retarded angle chamber 39. The second oil control valve 64 receives a command signal for maintaining the operating state in which lubricant oil is drained from the first restricting chamber 44 and the second restricting chamber 54.

Accordingly, since lubricant oil is supplied to each advanced angle chamber 38 through the advanced angle oil passage 75 and drained from each retarded angle chamber 39 through the retarded angle oil passage 76, the valve timing VT is advanced. Further, since lubricant oil is drained from the first restricting chamber 44 and the second restricting chamber 54 through the first restricting oil passage 77 and the second restricting oil passage 78, respectively, the first and second restricting pins 41, 51 are maintained each in a state to be projected from the vane 36.

Specifically, the first and second restricting mechanisms 40, 50 operate in the manners described below.

As illustrated in FIG. 6(a), when the rotation phase of the vane rotor 35 relative to the housing rotor 31 is retarded with respect to the third retarded angle phase PX3, the first restricting pin 41 and the second restricting pin 51 are arranged outside the first engagement groove 46 and the second engagement groove 56, respectively.

Referring to FIG. 6(b), when the rotation phase of the vane rotor 35 relative to the housing rotor 31 is the third retarded angle phase PX3, the second restricting pin 51 projects from the vane 36 and the pin distal end portion 51B is received in the second upper groove portion 58. In this state, the first restricting pin 41 is located outside the first engagement groove 46. When the fixing mechanism 4 is in this state, rotation of the vane rotor 35 relative to the housing rotor 31 in the retarding direction with respect to the third retarded angle phase PX3 is restricted.

With reference to FIG. 6(c), when the rotation phase of the vane rotor 35 relative to the housing rotor 31 is the first retarded angle phase PX1, the first restricting pin 41 projects from the vane 36 and the pin distal end portion 41B is received in the first upper groove portion 48. In this state, the second restricting pin 51 is located in the second upper groove portion 58. When the fixing mechanism 4 is in this state, rotation of the vane rotor 35 relative to the housing rotor 31 in the retarding direction with respect to the first retarded angle phase PX1 is restricted.

As illustrated in FIG. 7(a), when the rotation phase of the vane rotor 35 relative to the housing rotor 31 is the second retarded angle phase PX2, the first restricting pin 41 proceeds beyond the first stepped portion 49 and the pin distal end portion 41B is received in the first lower groove portion 47. In this state, the second restricting pin 51 is located in the second upper groove portion 58. When the fixing mechanism 4 is in this state, rotation of the vane rotor 35 relative to the housing rotor 31 in the retarding direction with respect to the second retarded angle phase PX2 is restricted.

With reference to FIG. 7(b), when the rotation phase of the vane rotor 35 relative to the housing rotor 31 is the middle phase PM, the second restricting pin 51 proceeds beyond the second stepped portion 59 and the pin distal end portion 51B is received in the second lower groove portion 57. In this state, a side surface of the pin distal end portion 41B of the first restricting pin 41 is held in contact with the first advanced angle end portion 46A of the first lower groove portion 47. Also, a side surface of the pin distal end portion 51B of the second restricting pin 51 is held in contact with the second stepped end portion 56C of the second lower groove portion 57.

When the fixing mechanism 4 is in this state, engagement between the first restricting pin 41 and the first advanced angle end portion 46A and engagement between the second restricting pin 51 and the second stepped end portion 56C restrict rotation of the vane rotor 35 relative to the housing rotor 31. In other words, the rotation phase of the vane rotor 35 relative to the housing rotor 31 is fixed at the middle phase PM and the valve timing VT is fixed at the middle angle VTmdl.

Fixing by the variable mechanism 30 in engine starting will hereafter be described.

When the engine is stopped, the rotation phase of the vane rotor 35 relative to the housing rotor 31 is maintained at the middle phase PM. Further, lubricant oil is drained from the first restricting chamber 44 and the second restricting chamber 54. This causes the first restricting spring 42 and the second restricting spring 52 to maintain the first restricting pin 41 and the second restricting pin 51, respectively, each in a state to proceed in the projecting direction ZA.

If the valve timing VT is not fixed at the middle angle VTmdl when the engine is stopped, lubricant oil is drained from each advanced angle chamber 38 and each retarded angle chamber 39 as the engine is maintained in a stopped state. This maintains the rotation phase of the vane rotor 35 relative to the housing rotor 31 at the maximum retarded angle phase PL. Lubricant oil is drained also from the first restricting chamber 44 and the second restricting chamber 54. This causes the first restricting spring 42 and the second restricting spring 52 to maintain the first restricting pin 41 and the second restricting pin 51, respectively, each in a state to proceed in the projecting direction ZA.

Then, after cranking is initiated, torque change in the intake camshaft 22 rotates the vane rotor 35 relative to the housing rotor 31 in the advancing direction. This causes sequential engagement between the restricting pins 41, 51 and the corresponding engagement grooves 46, 56 in the order represented in FIGS. 6 and 7. The valve timing VT is thus fixed at the middle angle VTmdl.

The content of the stop-time valve timing control will hereafter be described.

In the normal stop-time control, when an engine stopping demand based on deactivation of the ignition switch is detected, fixing by the variable mechanism 30 is started before engine stopping is initiated in response to the engine stopping demand. Then, when it is detected or can be assumed that the valve timing VT has been fixed at the middle angle VTmdl, a flag indicating a valve timing VT fixed at the middle angle VTmdl (hereinafter, a fixing completion flag) is turned on and engine operation is stopped in response to the engine stopping demand. As a result, a subsequent cycle of engine starting will be performed with the valve timing VT fixed at the middle angle VTmdl.

In the emergency stop-time control, fixing by the variable mechanism 30 is started when engine stall is detected. Specifically, after the engine stall, there is still a certain length of time until rotation of the engine 1 stops completely. Accordingly, it may be possible to fix the valve timing VT at the middle angle VTmdl through an attempt to fix the valve timing VT. However, since the engine stall continuously decreases the hydraulic pressure supplied to the variable mechanism 30, it may be assumed that hydraulic pressure control for the variable mechanism 30 is difficult. If this is the case, fixing by the variable mechanism 30 must be suspended.

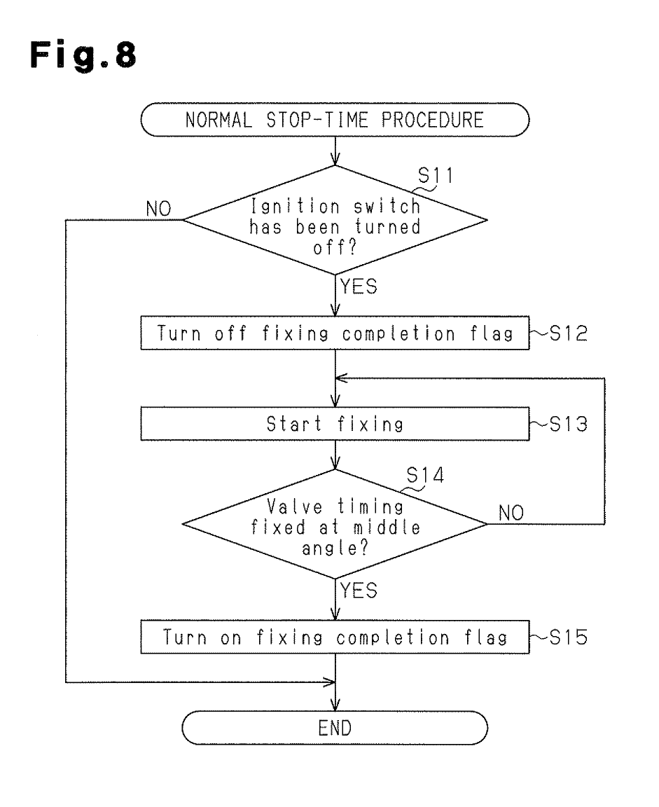

Referring to FIG. 8, the content of a normal stop-time procedure representing specific steps of the normal stop-time control will hereafter be described. The normal stop-time procedure is executed by the electronic control unit 91. Once the procedure is suspended, the procedure is re-started from the beginning after the engine 1 is started in a subsequent cycle.

The electronic control unit 91 carries out the steps described below as the normal stop-time control.

If it is determined that the ignition switch has not been turned off in Step S11, the determination of Step Sll is repeated after a predetermined calculation cycle.

When it is determined that the ignition switch has been turned off in Step S11, the fixing completion flag, which indicates that the valve timing VT is fixed at the middle angle VTmdl, is turned off in Step S12. Subsequently, in Step S13, fixing by the variable mechanism 30 is started through control by the hydraulic pressure control device 62.

If it is determined that the valve timing VT is not fixed at the middle angle VTmdl in Step S14, the determination of Step S13 is repeated after a predetermined calculation cycle. Determination of whether the valve timing VT is fixed at the middle angle VTmdl is carried out based on a calculation value of the valve timing VT obtained from the crank angle CA and the intake cam angle DA.

If it is determined that the valve timing VT is fixed at the middle angle VTmdl in Step S14, the fixing completion flag is turned on in Step S15 and the normal stop-time control is ended.

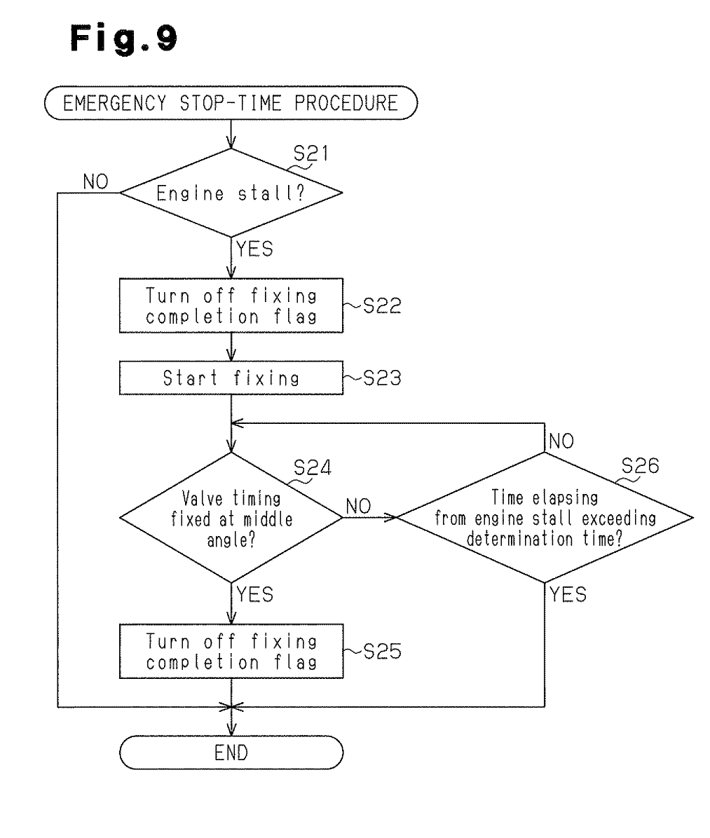

With reference to FIG. 9, the content of an emergency stop-time procedure, which defines specific steps of the emergency stop-time control, will now be described. The procedure is carried out by the electronic control unit 91. Once the procedure is suspended, the procedure is re-started from the beginning after the engine 1 is started in a subsequent cycle.

The electronic control unit 91 performs the steps described below as the emergency stop-time procedure.

If it is determined that engine stall has not occurred in Step S21, the determination of Step S21 is repeated after a predetermined calculation cycle. Specifically, it is determined that engine stall has occurred when the decrease rate of the engine speed NE is greater than a determination value and the engine speed NE is smaller than a reference value.

When it is determined that engine stall has occurred in Step S21, the fixing completion flag is turned off in Step S22. Next, in Step S23, fixing by the variable mechanism 30 is started through control by the hydraulic pressure control device 62.

If it is determined that the valve timing VT is not fixed at the middle angle VTmdl in Step S24 and that the time that has elapsed since occurrence of engine stall is shorter than or equal to a determination time in Step S26, the determination of Step S24 is repeated after a predetermined calculation cycle.

When it is determined that the valve timing VT is fixed at the middle angle VTmdl in Step S24, the fixing completion flag is turned off in Step S25 and the emergency stop-time control is ended. If it is determined that the valve timing VT is not fixed at the middle angle VTmdl in Step S24 and that the time that has elapsed since occurrence of engine stall is longer than the determination time in Step S26, the emergency stop-time control is ended without manipulating the fixing completion flag.

The determination time is memorized in advance by the electronic control unit 91 as the time that ensures execution of hydraulic pressure control on the variable mechanism 30 after occurrence of engine stall. If the time that has elapsed since the occurrence of engine stall exceeds the determination time, a sufficient level of hydraulic pressure cannot be supplied to the variable mechanism 30. This makes it difficult to change the valve timing VT by controlling the variable mechanism 30 through hydraulic pressure.

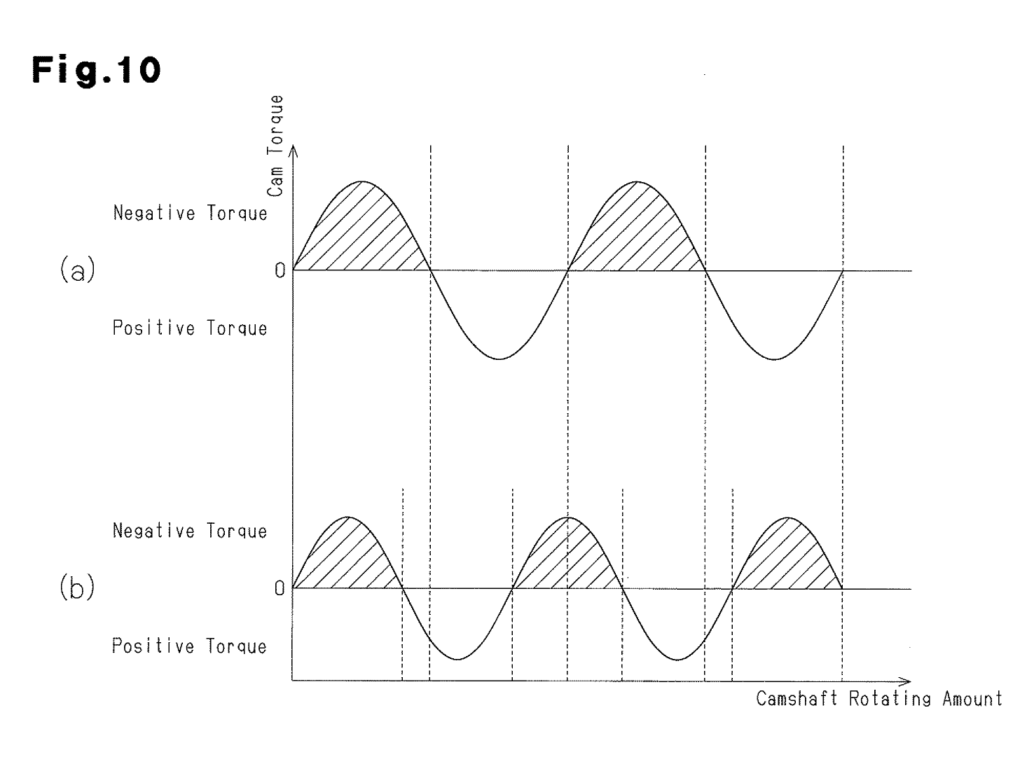

Referring to FIGS. 5 to 7 and FIG. 10, relationship between torque change of a camshaft and rotation of the vane rotor 35 relative to the housing rotor 31 will hereafter be described. FIG. 10(a) schematically represents torque change of a camshaft at the time when the engine speed NE is relatively small. FIG. 10(b) schematically represents torque change of a camshaft at the time when the engine speed NE is relatively great.

As represented by FIG. 10, torque of the intake camshaft 22 or the exhaust camshaft 24 (hereinafter, referred to as cam torque) cyclically changes as the intake camshaft 22 or the exhaust camshaft 24 rotates. In the description below, cam torque acting in a camshaft rotating direction will be referred to as negative torque and cam torque acting in the opposite direction to the camshaft rotating direction will be referred to as positive torque.

If negative torque is generated in the intake camshaft 22 when the cam torque change allows the vane rotor 35 to rotate relative to the housing rotor 31, the vane rotor 35 rotates relative to the housing rotor 31 in the advancing direction. In contrast, if positive torque is generated in the intake camshaft 22, the vane rotor 35 rotates relative to the housing rotor 31 in the retarding direction. Hereinafter, operation of the variable mechanism 30 in which the vane rotor 35 rotates relative to the housing rotor 31 based on the negative torque of the intake camshaft 22 will be referred to as autonomous advancement.

As illustrated in FIGS. 6 and 7, in the variable mechanism 30 including the fixing mechanism 4, the autonomous advancement of the variable mechanism 30 sequentially brings about engagement between the first and second restricting pins 41, 51 and the corresponding engagement grooves 46, 56.

However, when the rotating amount of the vane rotor 35 relative to the housing rotor 31 is small, or, for example, the vane rotor 35 is arranged at the maximum retarded angle phase PL and the rotating amount of the vane rotor 35 caused by cam torque change is smaller than the step width L4 (see FIG. 5), the second restricting pin 51 is prevented from projecting toward the second upper groove portion 58. Accordingly, if positive torque is generated in the intake camshaft 22, the vane rotor 35 rotates relative to the housing rotor 31 in the retarding direction. That is, the rotation phase of the vane rotor 35, which has been temporarily changed to an advanced angle phase with respect to the maximum retarded angle phase PL, is returned to the maximum retarded angle phase PL or a phase in the vicinity of the maximum retarded angle phase PL. This operation occurs also in the stage before the first restricting pin 41 is engaged with the first upper groove portion 48, the stage before the first restricting pin 41 is received in the first lower groove portion 47, and the stage before the second restricting pin 51 is engaged with the second lower groove portion 57.

When the rotating amount of the vane rotor 35 caused by the cam torque change is small, advancement caused by negative torque and retardation caused by positive torque are repeated in such a range that the vane rotor 35 does not reach the third retarded angle phase PX3, as has been described. This hampers the function of the fixing mechanism 4, which is the function for restricting rotation of the vane rotor 35 in the retarding direction in a stepped manner. That is, as long as the vane rotor 35 is retarded and advanced repeatedly in the aforementioned range, the valve timing VT cannot be fixed at the middle angle VTmdl. The variable mechanism 30 operates in this manner also at the time when the vane rotor 35 is located between the third retarded angle phase PX3 and the first retarded angle phase PX1, the time when the vane rotor 35 is arranged between the first retarded angle phase PX1 and the second retarded angle phase PX2, and the time when the vane rotor 35 is located between the second retarded angle phase PX2 and the middle phase PM.

Accordingly, the starting control of the first embodiment includes control (speed reduction control) for increasing the amount of rotation of the vane rotor 35 relative to the housing rotor 31 caused by torque change (hereinafter, the swing amount of the vane rotor 35) per camshaft rotation. In the speed reduction control, when engine starting is performed without fixing the valve timing VT at the middle angle VTmdl (released starting), the engine speed NE at the time of cranking is controlled in such a manner as to raise the change amount of cam torque, compared to when engine starting is carried out with the valve timing VT fixed at the middle angle VTmdl (fixed starting). As a result, the swing amount of the vane rotor 35 with the speed reduction control in the released starting is great compared to the swing amount of the vane rotor 35 without the speed reduction control in the released starting.

The swing amount of the vane rotor 35 is in correlation with an integral value of negative torque per camshaft rotation. That is, the swing amount of the vane rotor 35 increases as the integral value of the negative torque increases. In FIG. 10, the gridded ranges each correspond to an integral value of negative torque per camshaft rotation.

The integral value of the negative torque is in correlation with the length of one cycle of change in cam torque and the peak value of the cam torque in each cycle. In other words, as the length of each change cycle of the cam torque and the torque peak value in the cycle become greater, the integral value of the negative torque becomes greater.

The length of each change cycle of the cam torque and the peak value of the cam torque in the cycle are in correlation with the engine speed NE. That is, as the engine speed NE becomes lower, the length of one change cycle of the cam torque and the peak value of the cam torque become greater.

With reference to FIG. 10, if the length of each change cycle of camshaft torque and the torque peak value in the cycle in the state A with a relatively small engine speed NE (FIG. 10(a)) are compared with the corresponding values in the state B with a relatively great engine speed NE (FIG. 10(b)), the state A exhibits a long change cycle of torque change and a great peak value of the torque change, compared to the state B. As a result, the integral value of the negative torque per camshaft rotation is greater in the state A than in the state B. The swing amount of the vane rotor 35 is thus greater in the state A than in the state B. The relationship that has been described is satisfied between positive torque and the swing amount of the vane rotor 35.

In the starting control of the first embodiment, based on the facts that have been described, the engine speed NE at the time of released starting (a first engine speed) is lowered compared to the engine speed NE at the time of fixed starting (a second engine speed), thus increasing the change amount of cam torque in the released starting compared to the change amount of cam torque in the fixed starting. Further, the load of the starter motor 16 at the time of released starting (a first motor load) is raised compared to the load of the starter motor 16 at the time of fixed starting (a second motor load), thus decreasing the engine speed NE in the released starting compared to the engine speed NE in the fixed starting. Also, in the released starting, a prescribed auxiliary electric device (hereinafter, a selected auxiliary electric device) out of one or multiple auxiliary electric devices 82 is actuated. In the fixed starting, the selected auxiliary electric device is de-actuated. In this manner, the load of the starter motor 16 in the released starting is increased compared to the load of the starter motor 16 in the fixed starting.

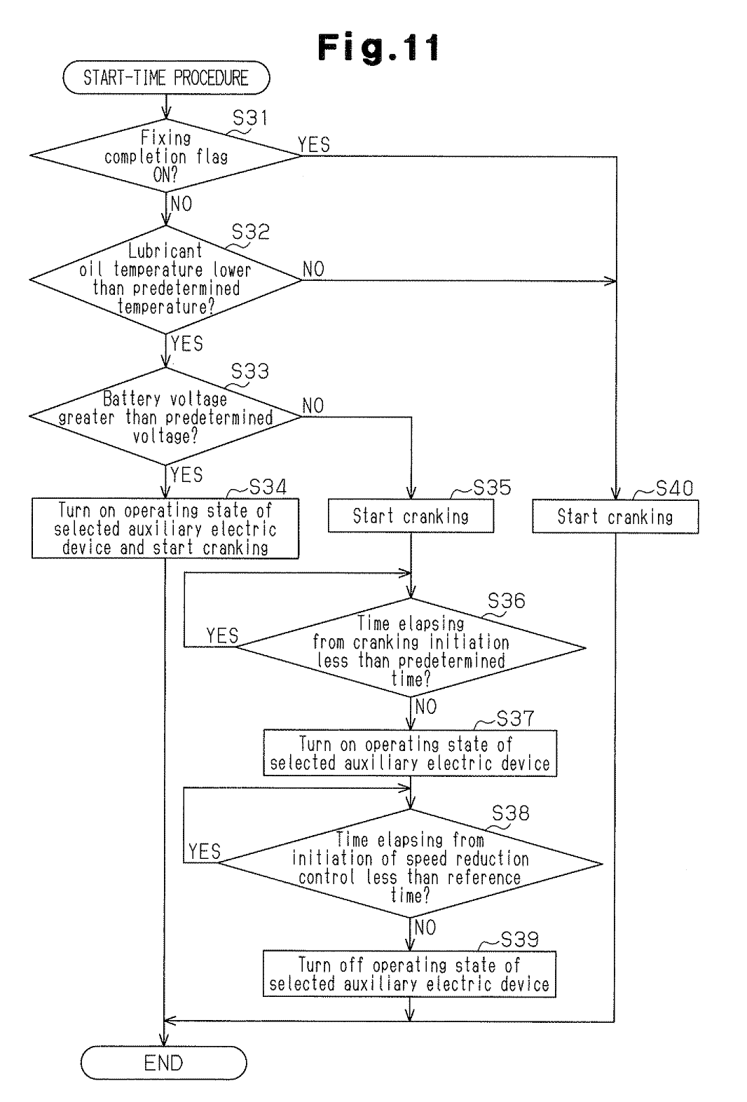

Referring to FIG. 11, the content of a start-time procedure, which defines specific steps for the starting control, will hereafter be described. The procedure is repeatedly performed by the electronic control unit 91 at predetermined calculation cycles.

The electronic control unit 91 carries out the steps described below as the start-time procedure. The procedure is initiated when the ignition switch is turned on, or, in other words, an engine starting demand is generated.

In Step S31, it is determined whether the fixing completion flag has been turned on. In Step S32, it is determined whether a calculation value of the lubricant oil temperature TL is smaller than a predetermined temperature TLX. In Step S33, it is determined whether a calculation value of the battery voltage By is greater than a predetermined voltage BVX.

The predetermined temperature TLX is memorized in advance by the electronic control unit 91 as the value in accordance with which to determine that starting of the engine 1 is highly likely to be hampered by a low temperature of the engine body 10 at the time when the valve timing VT is not fixed at the middle angle VTmdl. When the lubricant oil temperature TL is less than the predetermined temperature TLX, it is highly likely that starting of the engine 1 is hampered by a low temperature of the engine body 10. Accordingly, it is demanded that the valve timing VT be fixed at the middle angle VTmdl.

The predetermined voltage BVX is memorized in advance by the electronic control unit 91 as the value in accordance with which to determine that it is highly likely that torque of the starter motor 16 necessary for cranking is not ensured due to a low battery voltage BV. When the battery voltage BV is smaller than or equal to the predetermined voltage BVX, it is highly likely that torque for cranking falls short due to actuation of another electric device than the starter motor 16. Accordingly, it is demanded that the actuation of the electric device be suspended.

The results of the determinations in Steps S31 to S33 are classified according to three types as will be described.

(Determination Result A) Determination in Step 31 that the fixing completion flag has been turned on. Alternatively, determination in Step S31 that the fixing completion flag has been turned off combined with determination in Step S32 that the lubricant oil temperature TL is higher than or equal to the predetermined temperature TLX.

(Determination Result B) Determination in Step S31 that the fixing completion flag has been turned off in combination with determination in Step 532 that the lubricant oil temperature TL is less than the predetermined temperature TLX and determination in Step S33 that the battery voltage BV is smaller than or equal to the predetermined voltage BVX.

(Determination Result C) Determination in Step S31 that the fixing completion flag has been turned off combined with determination in Step S32 that the lubricant oil temperature TL is lower than the predetermined temperature TLX and determination in Step S33 that the battery voltage BV is greater than the predetermined voltage BVX.

When the determination result A is obtained, cranking by the starter motor 16 is initiated in Step S40. For the determination result B, the cranking is started in Step S35. In this case, Steps S36 to S39 must follow. For the determination result C, the procedure for decreasing the engine speed NE at the time of cranking is carried out in Step 34 before initiating cranking by the starter motor 16.

Specifically, in Step S34, the engine speed NE at the time of cranking is decreased by performing the procedure described below. That is, the operating state of the selected auxiliary electric device (an auxiliary electric device 82) is changed from a deactivated state to an activated state. In this case, the operating state of the seat heater is changed from a deactivated state to an activated state. This reduces the electric current supplied from the battery 81 to the starter motor 16, compared to cranking at the time when the seat heater is turned off. Torque of the starter motor 16 is thus also decreased. As a result, the engine speed NE at the time when the seat heater is turned on is lower than the engine speed NE at the time when the seat heater is turned off.

When the determination result B is obtained, initiation of cranking is followed by the steps described below.

If it is determined that the time that has elapsed since initiation of cranking is less than a predetermined time in Step S36, the determination of Step S36 is repeated after a predetermined calculation cycle.

If it is determined that the elapsed time is longer than or equal to the predetermined time in Step S36, the operating state of the selected auxiliary electric device is changed from a deactivated state to an activated state as in Step S34.

The predetermined time is memorized in advance by the electronic control unit 91 as the time corresponding to the period from when cranking is started to when an initial compression stroke is completed. When the time that has elapsed since the start of cranking is shorter than the predetermined time, a particularly great cranking torque is needed to complete the initial compression stroke. Accordingly, to prevent starting of the engine 1 from being hampered, it is demanded to supply a sufficient electric current to the starter motor 16.

If it is determined that the time that has elapsed since activation of the selected auxiliary electric device (the time that has elapsed since initiation of the speed reduction control) is shorter than a reference time in Step S38, the determination of Step S38 is repeated after a predetermined calculation cycle.

When it is determined that the elapsed time is longer than or equal to the reference time in Step S38, the operating state of the selected auxiliary electric device is changed from the activated state to the deactivated state.

The reference time is memorized in advance by the electronic control unit 91 as the period from when the speed reduction control is started to when the valve timing VT reaches the middle angle VTmdl. When the time that has elapsed since activation of the selected auxiliary electric device is shorter than the reference time, it is assumed that the valve timing VT is not fixed at the middle angle VTmdl. Accordingly, it is demanded that the selected auxiliary electric device be maintained in the activated state.

As has been described in detail, the first embodiment has the advantages described below.

(1) In the first embodiment, load of the starter motor 16 in the released starting (first motor load) is greater than load of the starter motor 16 in the fixed starting (second motor load). In other words, the torque applied from the starter motor 16 to the crankshaft 15 in the released starting (first torque) is smaller than the torque applied from the starter motor 16 to the crankshaft 15 in the fixed starting (second torque). Accordingly, the engine speed NE is lower in the released starting than in the fixed starting. In other words, the engine speed NE in the released starting (first engine speed) is smaller than the engine speed NE in the fixed starting (second engine speed). Accordingly, the length and the peak value of each change cycle of the camshaft torque are greater in the released starting than in the fixed starting. The change amount of the cam torque per rotation of the intake camshaft 22 thus becomes greater in the released starting than in the fixed starting. This facilitates regulation of the valve timing VT to the middle angle VTmdl. As a result, the valve timing VT is fixed at the middle angle VTmdl at increased frequency in engine starting.

(2) As the engine temperature in engine starting increases, the state of combustion improves. Accordingly, under a high lubricant oil temperature TL, starting of the engine 1 is hampered with decreased frequency even if the valve timing VT is not fixed at the middle angle VTmdl. In the first embodiment, the speed reduction control is performed only when the lubricant oil temperature TL is lower than the predetermined temperature TLX. As a result, when it is unlikely that engine starting is hampered, the engine speed NE is allowed to rise rapidly. If engine starting is carried out under a low lubricant oil temperature TL, the valve timing VT is fixed at the middle angle VTmdl at increased frequency. As a result, the engine starting is hampered with decreased frequency.

(3) In the first embodiment, the speed reduction control is not carried out in the predetermined time corresponding to the period from when cranking is started to when an initial compression stroke is completed, which is an immediate period after engine starting in which great torque is necessary for cranking. This decreases the frequency at which starting of the engine 1 is hampered by insufficient torque of the starter motor 16.

(4) In the first embodiment, when the battery voltage BV of the battery 81, which supplies electric power to the starter motor 16, is less than the predetermined voltage BVX, or, in other words, when it is likely that torque needed by the starter motor 16 in cranking is not ensured, the speed reduction control is not performed until the predetermined time elapses. This decreases the frequency at which starting of the engine 1 is hampered by insufficient torque of the starter motor 16.

(5) In the first embodiment, the speed reduction control is ended after the reference time, which is a sufficient period of time for the valve timing VT to reach the middle angle VTmdl, since the initiation of the speed reduction control. Accordingly, the speed reduction control is prevented from being executed when the valve timing VT is fixed at the middle angle VTmdl. Further, compared to a case in which the speed reduction control is continued until completion of starting of the engine 1, the power consumed by the battery 81 is decreased.

(6) In the first embodiment, the restricting mechanisms 40, 50 restrict retardation of the valve timing VT when the valve timing VT is advanced from an angle retarded with respect to the middle angle VTmdl due to cam torque change in engine starting. Accordingly, when the valve timing VT of the intake valve is at the middle angle VTmdl in engine starting, retardation of the valve timing VT is restricted by the restricting mechanisms 40, 50. This increases the frequency at which the valve timing VT reaches the middle angle VTmdl.

### Second Embodiment

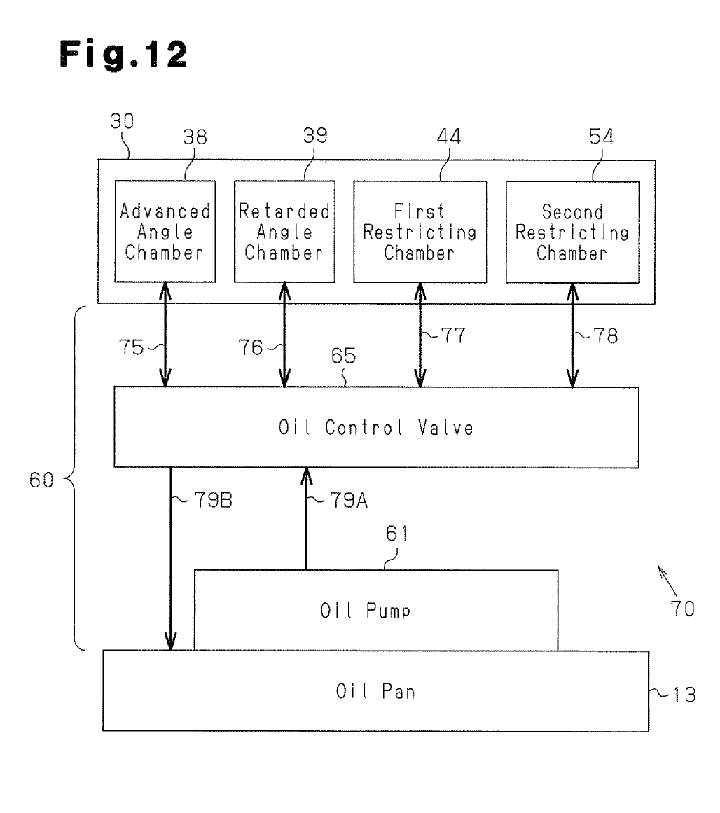

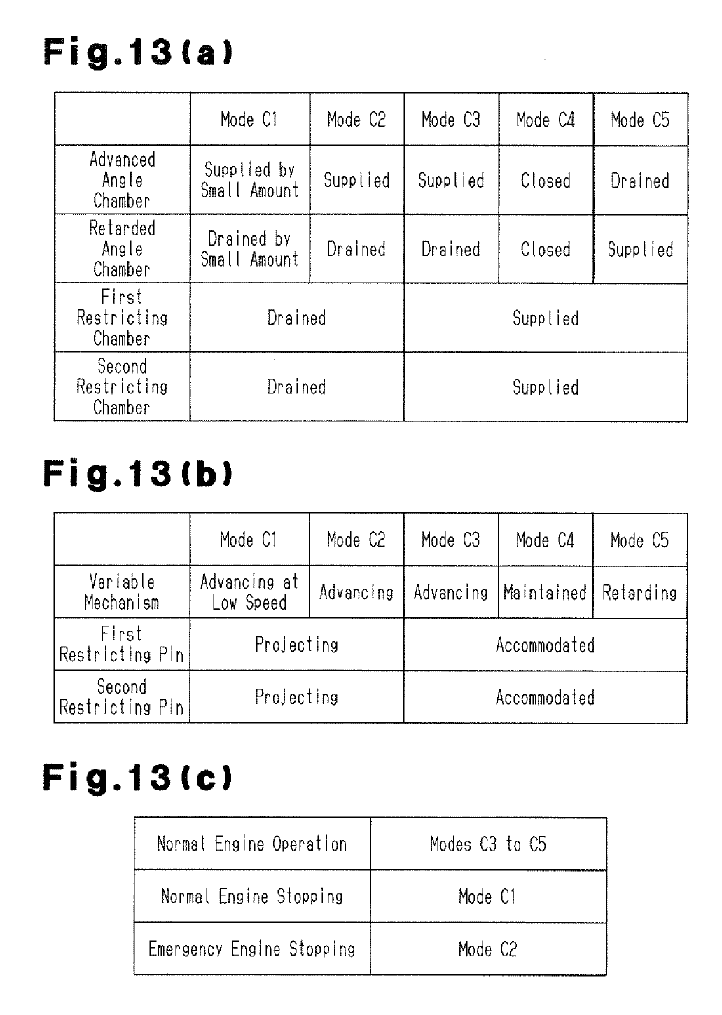

With reference to FIGS. 12 and 13, a second embodiment of the present invention will hereafter be described. The description below is focused on the modified points from the first embodiment. Same or like reference numerals are given to components of the second embodiment that are the same as or like corresponding components of the first embodiment. Detailed description of these components is omitted in certain parts of the description.

FIG. 12 illustrates flow paths of lubricant oil between the lubricating device 60 and the variable mechanism 30 of the second embodiment. The hydraulic pressure control device 62 of the first embodiment has the first oil control valve 63 and the second oil control valve 64 as the oil control valves. In contrast, the hydraulic pressure control device 62 of the second embodiment includes only the oil control valve 65. After having been pumped out from the oil pump 61, lubricant oil is supplied to the oil control valve 65 through an oil supply passage 79A.

The lubricant oil, which has been sent to the oil control valve 65, flows in the lubricant oil passage 70 in accordance with an operating mode of the oil control valve 65. Modes C1, C2, C3, C4, and C5 are prescribed as the operating modes of the oil control valve 65. In the description below, the flow amount of the lubricant oil and the operating speed of the variable mechanism 30 are compared from one operating mode to another under the condition that the displacement of the oil pump 61 is constant.

(a) When the oil control valve 65 operates in the mode C1, the oil control valve 65 is in such an operating state as to supply a small amount of lubricant oil to each advanced angle chamber 38, drain a small amount of lubricant oil from each retarded angle chamber 39, and drain lubricant oil from the first restricting chamber 44 and the second restricting chamber 54. In this state, the small amount of lubricant oil is supplied to the advanced angle chamber 38 via the advanced angle oil passage 75 and the small amount of lubricant oil is drained from the retarded angle chamber 39 through the retarded angle oil passage 76. Also, lubricant oil is drained from the first restricting chamber 44 and the second restricting chamber 54 through the first restricting oil passage 77 and the second restricting oil passage 78, respectively. The lubricant oil that has been drained from each retarded angle chamber 39, the first restricting chamber 44, and the second restricting chamber 54 is returned to the oil pan 13 via the oil control valve 65 and an oil drainage passage 79B.

(b) When the oil control valve 65 operates in the mode C2, the oil control valve 65 is in such an operating state as to supply a greater amount of lubricant oil to each advanced angle chamber 38 than in the mode C1, drain a greater amount of lubricant oil from each retarded angle chamber 39 than in the mode C1, and drain lubricant oil from the first restricting chamber 44 and the second restricting chamber 54. In this state, lubricant oil is supplied to the advanced angle chamber 38 via the advanced angle oil passage 75 and drained from the retarded angle chamber 39 through the retarded angle oil passage 76. Also, lubricant oil is drained from the first restricting chamber 44 and the second restricting chamber 54 through the first restricting oil passage 77 and the second restricting oil passage 78, respectively. The lubricant oil that has been drained from each retarded angle chamber 39, the first restricting chamber 44, and the second restricting chamber 54 is returned to the oil pan 13 via the oil control valve 65 and the oil drainage passage 79B.

(c) When the oil control valve 65 operates in the mode C3, the oil control valve 65 is in such an operating state as to supply a greater amount of lubricant oil to each advanced angle chamber 38 than in the mode C1, drain a greater amount of lubricant oil from each retarded angle chamber 39 than in the mode C1, and supply lubricant oil to the first restricting chamber 44 and the second restricting chamber 54.

In this state, lubricant oil is supplied to the advanced angle chamber 38 via the advanced angle oil passage 75 and drained from the retarded angle chamber 39 through the retarded angle oil passage 76. Also, lubricant oil is supplied to the first restricting chamber 44 and the second restricting chamber 54 through the first restricting oil passage 77 and the second restricting oil passage 78, respectively. The lubricant oil that has been drained from each retarded angle chamber 39 is returned to the oil pan 13 via the oil control valve 65 and the oil drainage passage 79B.

(d) When the oil control valve 65 operates in the mode C4, the oil control valve 65 is in such an operating state as to close the advanced angle chambers 38 and the retarded angle chambers 39 and supply lubricant oil to the first restricting chamber 44 and the second restricting chamber 54. In this state, the lubricant oil in each advanced angle chamber 38 and each retarded angle chamber 39 is maintained. Further, lubricant oil is supplied to the first restricting chamber 44 and the second restricting chamber 54 through the first restricting oil passage 77 and the second restricting oil passage 78, respectively.

(e) When the oil control valve 65 operates in the mode C5, the oil control valve 65 is in such an operating state as to drain lubricant oil from each advanced angle chamber 38 and supply lubricant oil to each retarded angle chamber 39, the first restricting chamber 44, and the second restricting chamber 54. In this state, lubricant oil is drained from the advanced angle chamber 38 via the advanced angle oil passage 75 and supplied to the retarded angle chamber 39 through the retarded angle oil passage 76. Also, lubricant oil is supplied to the first restricting chamber 44 and the second restricting chamber 54 through the first restricting oil passage 77 and the second restricting oil passage 78, respectively. The lubricant oil that has been drained from each advanced angle chamber 38 is returned to the oil pan 13 via the oil control valve 65 and the oil drainage passage 79B.

FIGS. 13 generally represent the relationship between the operating modes of the oil control valve 65 and the supply/drainage state of lubricant oil for the advanced and retarded angle chambers 38, 39 and the restricting chambers 44, 54 (FIG. 13(a)) and the relationship between the operating modes and the operating manners of the variable mechanisms 30 and the restricting pins 41, 51 (FIG. 13(b)).

When the oil control valve 65 is in the mode C1, lubricant oil is supplied to each advanced angle chamber 38 by a smaller flow amount than that of the mode C2 and drained from each retarded angle chamber 39 by a smaller flow amount than that of the mode 02. Meanwhile, lubricant oil is drained from the restricting chambers 44, 54. The variable mechanism 30 is thus driven in the advancing direction at a lower speed than in the mode C2, applying force acting in the projecting direction ZA to the restricting pins 41, 51.

When the oil control valve 65 is in the mode C2, lubricant oil is supplied to each advanced angle chamber 38 by a greater flow amount than that of the mode C1 and drained from each retarded angle chamber 39 by a greater flow amount than that of the mode C1. Meanwhile, lubricant oil is drained from the restricting chambers 44, 54. The variable mechanism 30 is thus driven in the advancing direction at a higher speed than in the mode C1, applying force acting in the projecting direction ZA to the restricting pins 41, 51.

When the oil control valve 65 is in the mode C3, lubricant oil is supplied to each advanced angle chamber 38 by a greater flow amount than that of the mode C1 and drained from each retarded angle chamber 39 by a greater flow amount than that of the mode C1. Meanwhile, lubricant oil is supplied to the restricting chambers 44, 54. The variable mechanism 30 is thus driven in the advancing direction at a higher speed than in the mode C1, applying force acting in the accommodating direction ZB to the restricting pins 41, 51.

When the oil control valve 65 is in the mode C4, the lubricant oil in the advanced angle chambers 38 and the retarded angle chambers 39 is maintained. Meanwhile, lubricant oil is supplied to the restricting chambers 44, 45. This maintains a relative rotation phase of the vane rotor 35 with respect to the housing rotor 31 and applies force acting in the accommodating direction ZB to the restricting pins 41, 51.

When the oil control valve 65 is in the mode C5, lubricant oil is drained from the advanced angle chambers 38 and supplied to the retarded angle chambers 39. Meanwhile, lubricant oil is sent to the restricting chambers 44, 54. This drives the variable mechanism 30 in the retarding direction, thus applying force acting in the accommodating direction ZB to the restricting pins 41, 51.

Referring to FIG. 13(c), the oil control valve 65 is switched from one drive mode to another based on an engine operating state in the manner described below.

In normal engine operation, any mode is selected from the modes C3 to C5 in correspondence with the engine operating state.

In normal engine stopping, if the valve timing VT is retarded with respect to the middle angle VTmdl when an engine stopping demand is detected, the mode C1 is selected. If the valve timing VT is advanced with respect to the middle angle VTmdl when an engine stopping demand is detected, the mode C5 is selected and, after the valve timing VT becomes retarded with respect to the middle angle VTmdl, the mode C1 is selected. That is, in the normal stop-time procedure (FIG. 8) of the second embodiment, an operating mode of the oil control valve 65 is selected in this manner in Step S13.

In emergency engine stopping, if the valve timing VT is retarded with respect to the middle angle VTmdl when engine stall is detected, the mode C2 is selected. If the valve timing VT is advanced with respect to the middle angle VTmdl when engine stall is detected, the mode C5 is selected continuously for a predetermined time before the mode C2 is selected. In other words, in the emergency stop-time procedure (FIG. 9) of the second embodiment, an operating mode of the oil control valve 65 is selected in this manner in Step S23.

As has been described, in addition to the advantage (1) that the valve timing VT is fixed at the middle angle VTmdl at increased frequency in engine starting and the advantages (2) to (6) of the first embodiment, the second embodiment has the advantages described below.

(7) If the driving speed of the variable mechanism 30 (the relative rotating speed of the housing rotor 31 and the vane rotor 35) is excessively high when the valve timing VT is to be fixed at the middle angle VTmdl, it is highly likely that the restricting pins 41, 51 pass the corresponding lower groove portions 47, 57 without being received in the lower groove portions 47, 57.

However, in the second embodiment, the mode C1 is selected as the operating mode of the oil control valve 65 for normal engine stopping. Accordingly, the valve timing VT is changed by the fixing mechanism 4 with the driving speed of the variable mechanism 30 in the advancing direction maintained lower than that of the mode C2. This decreases the frequency at which a problem caused by an excessively high driving speed of the variable mechanism 30 occurs.

(8) In emergency engine stopping, the hydraulic pressure applied to the variable mechanism 30 only decreases as the time elapses. Accordingly, to fix the valve timing VT at the middle angle VTmdl when in the emergency engine stopping, it is demanded that the valve timing VT is adjusted to the middle angle VTmdl at an early stage compared to when in the normal engine stopping.

However, in the second embodiment, the mode C2 is selected as the operating mode of the oil control valve 65 for the emergency engine stopping. Accordingly, the valve timing VT is changed by the fixing mechanism 4 with the driving speed of the variable mechanism 30 in the advancing direction maintained higher than that of the mode C1. This increases the frequency at which the valve timing VT is fixed at the middle angle VTmdl in the emergency engine stopping.

### Other Embodiments

The present invention is not restricted to the illustrated embodiments but may be embodied in the forms described below. Each of the modified examples described below is not only for use in the illustrated embodiments but also for use as combined with a different modified example.

In the start-time procedure (FIG. 11) of the illustrated embodiments, it is determined whether the valve timing VT is fixed at the middle angle VTmdl in a subsequent engine starting cycle based on whether the fixing completion flag, which is operated when the engine is stopped, is turned on or off. However, determination of whether the valve timing VT is fixed at the middle angle VTmdl may be carried out by estimating the valve timing VT when an engine starting demand is detected.

In the start-time procedure (FIG. 11) of the illustrated embodiments, the speed reduction control is performed when it is determined that the lubricant oil temperature TL is greater than or equal to the predetermined temperature TLX. However, this may be modified as described below. Specifically, determination of whether the lubricant oil temperature TL is lower than the predetermined temperature TLX may be omitted. The speed reduction control is performed when the lubricant oil temperature TL is higher than or equal to the predetermined temperature TLX.

In the start-time procedure (FIG. 11) of the illustrated embodiments, the timing for starting the speed reduction control is selected depending on whether the battery voltage BV is greater than the predetermined voltage BVX. However, this may be modified as will be described. Specifically, the power consumption of the battery 81 in cranking is estimated when an engine starting demand is detected. Based on the estimated power consumption, torque of the starter motor 16 in cranking is estimated. Using the estimated torque, the timing for starting the speed reduction control is selected. In this case, selection of the timing may employ the method described below, for example. Specifically, if the estimated torque exceeds a determination value, the speed reduction control is initiated before or simultaneously with the start of cranking. When the estimated torque is smaller than or equal to the determination value, the speed reduction control is started after a predetermine time has elapsed since the start of cranking.

In the start-time procedure (FIG. 11) of the illustrated embodiments, when the battery voltage BV is less than the predetermined voltage BVX, the speed reduction control is initiated after the predetermined time has elapsed since the start of cranking. However, this may be modified as described below. Specifically, it may be determined whether an initial compression stroke has been finished since the start of cranking. The speed reduction control is started when it is determined that the compression stroke has been finished. Determination of whether an initial compression stroke has been finished may be carried out based on, for example, whether the number of rotation of the engine 1 since the start of cranking is greater than a determination value.

In the start-time procedure (FIG. 11) of the illustrated embodiments, the timing for starting the speed reduction control is selected depending on whether the battery voltage BV exceeds the predetermined voltage BVX. However, determination of whether the battery voltage BV is greater than the predetermined voltage BVX may be omitted. In this case, as the timing for starting the speed reduction control, any one of the items (A), (B), and (C) may be selected.

(A) The speed reduction control is performed after an engine starting demand has been detected and cranking is started afterwards.

(B) The speed reduction control is executed after cranking is started.

(C) The speed reduction control is carried out after a predetermined time has elapsed since the start of cranking.

In the start-time procedure (FIG. 11) of the illustrated embodiments, if the battery voltage BV is greater than the predetermined voltage BVX, cranking is started after the speed reduction control has been initiated. However, this may be modified as described below. Specifically, when the battery voltage BV exceeds the predetermined voltage BVX, cranking is started first and the speed reduction control is initiated after a predetermined time has elapsed since the start of cranking.

In the start-time procedure (FIG. 11) of the illustrated embodiments, the speed reduction control is ended when it is determined that the time that has elapsed since initiation of the speed reduction control is longer than or equal to the reference time. However, the condition for ending the speed reduction control may be changed to either one of the items (A) and (B), as described below.

(A) The speed reduction control is ended when it is determined that the number of rotation of the engine 1 or the engine speed NE is greater than a corresponding determination value. The determination values for the number of rotation and the engine speed NE are both set as a value corresponding to a period of time necessary for the valve timing VT to reach the middle angle VTmdl after the speed reduction control is started.

(B) The speed reduction control is ended when it is determined that the valve timing VT has been fixed at the middle angle VTmdl.

In the start-time procedure (FIG. 11) of the illustrated embodiments, when the battery voltage BV is less than the predetermined voltage BVX, the speed reduction control is ended if the time that has elapsed since the start of the speed reduction control is longer than or equal to the reference time. However, the procedure for ending the speed reduction control based on the elapsed time may be omitted.

The start-time procedure (FIG. 11) of the illustrated embodiments may include additional control as will be described. Specifically, when the battery voltage BV exceeds the predetermined voltage BVX, the speed reduction control is ended when the time that has elapsed since initiation of the speed reduction control is longer than or equal to the reference time.

In the start-time procedure (FIG. 11) of the illustrated embodiments, the engine speed NE is decreased by changing the operating state of the selected auxiliary electric device from a deactivated state to an activated state. However, the engine speed NE may be decreased by increasing output of the selected auxiliary electric device in an activated state.

In the start-time procedure (FIG. 11) of the illustrated embodiments, a seat heater has been cited as the selected auxiliary electric device. However, the selected auxiliary electric device is not restricted to the seat heater. For example, a light in a passenger compartment may be used as the selected auxiliary electric device, instead of the seat heater. Also, as a device operating to decrease the engine speed NE, an electric device mounted in the engine 1 may be employed instead of an auxiliary electric device 82.

In the illustrated embodiments, the speed reduction control is performed as control for increasing the swing amount of the vane rotor 35 at the time of engine starting. However, the speed reduction control for increasing the swing amount of the vane rotor 35 is not restricted to the control illustrated in the embodiments but may be modified to either one of the items (A) and (B), as will be described.

(A) A motor capable of controlling the level of torque applied to the crankshaft 15 may be employed. The motor torque in released starting is thus decreased compared to the motor torque in fixed starting. This decreases the engine speed NE in the released starting compared to the engine speed NE in the fixed starting. As an example of one such motor, a motor-generator, which is mounted in a hybrid vehicle, may be cited.

(B) A variable resistance mechanism capable of varying resistance to rotation of the crankshaft 15 may be employed. The variable resistance mechanism is controlled in such a manner that the resistance to rotation of the crankshaft 15 in released starting is great compared to that in fixed starting. This decreases the engine speed NE in the released starting compared to the engine speed NE in the fixed starting. As an example of the variable resistance mechanism, a configuration that connects or disconnects a mechanism forming the resistance to rotation of the crankshaft 15 with respect to the crankshaft 15 through a gear or a clutch.

In the illustrated embodiments, the lubricant oil temperature TL is calculated based on the coolant temperature TW, which is detected by the coolant temperature sensor 94. However, the lubricant oil temperature TL may be detected by a sensor and used as an indicator value of the engine temperature.

In the illustrated embodiments, the lubricant oil temperature TL is estimated based on the coolant temperature TW, which is detected by the coolant temperature sensor 94. However, the parameter that can be used for estimation of the lubricant oil temperature TL is not restricted to the coolant temperature TW. For example, instead of or in addition to the coolant temperature TW, an integrated value of the fuel injection amount since initiation of starting of the engine 1 may be employed. Alternatively, the coolant temperature TW may be replaced by or combined with an integrated value of the intake air amount since initiation of starting of the engine 1.

In the illustrated embodiments, an estimated value of the lubricant oil temperature TL is used as an indicator value of the engine temperature. However, the estimated value of the lubricant oil temperature TL may be replaced by any suitable temperature that indicates the lubricant oil temperature TL. As one such indicator temperature, the temperature of a substance highly correlated with the lubricant oil temperature TL may be used. Specifically, at least one of the coolant temperature TW and the temperature of the engine body 10 may be used.

In the illustrated embodiments, the restricting pins 41, 51 are arranged in the vane rotor 35 and the engagement grooves 46, 56 are formed in the housing rotor 31. However, this configuration may be modified as described below. Specifically, at least one of the restricting pins 41, 51 may be formed in the housing rotor 31 with the corresponding one of the engagement grooves 46, 56 arranged in the vane rotor 35.

In the illustrated embodiments, as the configuration of the fixing mechanism 4, the configuration in which the hydraulic pressure in the restricting chambers 44, 45 moves the restricting pins 41, 51 in the accommodating direction ZB and the restricting springs 42, 52 move the restricting pins 41, 51 in the projecting direction ZA is employed. However, the configuration may be modified to the form described below. Specifically, the hydraulic pressure in the restricting chambers 44, 45 may move the restricting pins 41, 51 in the projecting direction ZA and the restricting springs 42, 52 may move the restricting pins 41, 51 in the accommodating direction ZB. In this case, to fix the valve timing VT at the middle angle VTmdl in engine starting, a structure capable of maintaining the hydraulic pressure in each restricting chamber 44, 45 even with the engine stopped is employed in the fixing mechanism 4.

In the illustrated embodiments, the first engagement groove 46 configured by the first lower groove portion 47 and the first upper groove portion 48 is formed in the first restricting mechanism 40. However, the first engagement groove 46 may be shaped in the modified form (A) or (B), as described below.

(A) The first lower groove portion 47 is replaced by a hole for receiving the first restricting pin 41, which is formed at a position corresponding to the middle phase PM. In this case, the first upper groove portion 48 is extended from the first stepped portion 49 to the hole corresponding to the middle phase PM.

(B) The first upper groove portion 48 is omitted and the first engagement groove 46 is configured only by the first lower groove portion 47.

In the illustrated embodiments, the second engagement groove 56 configured by the second lower groove portion 57 and the second upper groove portion 58 is formed in the second restricting mechanism 50. However, the second engagement groove 56 may be shaped in the modified form (A) or (B), as described below.

(A) The second lower groove portion 57 is replaced by a hole for receiving the second restricting pin 51, which is formed at a position corresponding to the middle phase PM.

(B) The second upper groove portion 58 is omitted and the second engagement groove 56 is configured only by the second lower groove portion 57.

In the illustrated embodiments, fixing is carried out when the ignition switch is turned off or engine stall is detected. However, the condition for the fixing is not restricted to this. For example, when the engine operating state has changed from a normal operating state to an idle operating state, generation of an engine stopping demand is highly likely to follow. Accordingly, fixing may be performed when the engine operating state is changed to the idle operating state. The valve timing INVT in idle operation is thus fixed at the middle angle INVTmdl.

In the second embodiment, the oil control valve 65 operating in the modes C1 to C5 is employed. However, the oil control valve 65 may be configured in the modified forms described below. That is, the mode C1 or C2 may be omitted. Alternatively, another operating mode may be added to the modes C1 to C5.

In the first embodiment, a lubricating device including two oil control valves is employed as the lubricating device 60. In the second embodiment, a lubricating device with a single oil control valve is used as the lubricating device 60. However, the lubricating device 60 may be configured in the modified form described below. For example, oil control valves may be formed independently for the respective chambers including the advanced angle chambers 38, the retarded angle chambers 39, and the restricting chambers 44, 54 to control the supply/drainage state of lubricant oil for the chambers.

In the illustrated embodiments, the hydraulic pressure in the variable mechanism 30 is controlled by the lubricating device 60. However, a hydraulic pressure control device for controlling the hydraulic pressure in the variable mechanism 30 may be arranged separately from the lubricating device 60. For example, the variable mechanism may have a hydraulic pressure control device including a structure for maintaining lubricant oil in the accommodation chamber 37, an oil passage for allowing lubricant oil to flow between each advanced angle chamber 38 and the associated retarded angle chamber 39, and a structure for permitting lubricant oil to flow between the advanced angle chamber 38 and the retarded angle chamber 39 in correspondence with the direction of cam torque as torque of a camshaft changes. The variable mechanism causes lubricant oil to flow from each retarded angle chamber 39 to the associated advanced angle chamber 38 when negative torque is generated. This rotates the vane rotor 35 relative to the housing rotor 31 in the advancing direction. When positive torque is produced, the lubricant oil is blocked from flowing between the advanced angle chamber 38 and the retarded angle chamber 39. This restricts rotation of the vane rotor 35 relative to the housing rotor 31 in the retarding direction. As a result, in engine starting, the valve timing VT is fixed at the middle angle VTmdl through autonomous advancement of the variable mechanism 30.

In the illustrated embodiments, the first restricting mechanism 40 and the second restricting mechanism 50 are each formed as a restricting mechanism for restricting rotation of the vane rotor 35 in the retarding direction at the time of autonomous advancement of the variable mechanism 30. However, the configuration of the restricting mechanism is not restricted to that illustrated in the embodiments. For example, in one employable restricting mechanism, each of the rotors may have a one-way clutch for selectively connecting and disconnecting the housing rotor 31 with respect to the vane rotor 35 and permitting rotation only in the direction of negative torque. In this manner, when the vane rotor 35 rotates relative to the housing rotor 31 as negative torque is generated, the restricting mechanism restricts movement of the rotation phase of the vane rotor 35 in the retarding direction with respect to the rotation phase of the vane rotor 35 after rotation of the vane rotor 35.

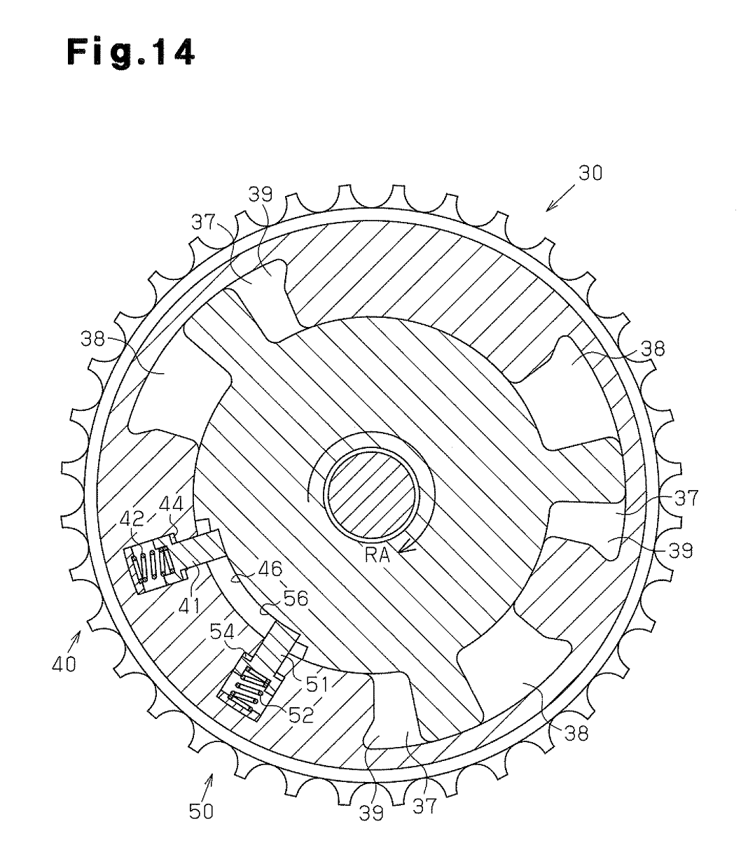

Although the variable mechanism 30 is configured in such a manner that the restricting pins 41, 51 move in the axial direction of the vane rotor 35 in the illustrated embodiments, the restricting pins 41, 51 may move in a radial direction of the vane rotor 35. Specifically, as illustrated in FIG. 14, the restricting pins 41, 51 are formed in one of the vanes 36 in such a manner that the restricting pins 41, 51 move in a radial direction of the vane rotor 35. The engagement grooves 46, 56 are formed in the housing rotor 31 at the positions corresponding to the restricting pins 41, 51.

In the illustrated embodiments, the present invention is used in the engine 1 having the variable mechanism 30 for changing the valve timing of the intake valve 21. However, the invention may be employed in an internal combustion engine having a variable mechanism for changing the valve timing of the exhaust valve 23. In this case, as indicated by the double dashed lines in FIG. 1, the engine 1 includes a variable mechanism 130 for changing the valve timing of the exhaust valve 23. The valve timing of the exhaust valve 23 is fixed at the middle angle at increased frequency through procedures similar to the normal stop-time procedure (FIG. 5), the emergency stop-time procedure (FIG. 6), and the start-time procedure (FIG. 11).

The configuration of a variable valve device for which the invention is employable is not restricted to the configurations illustrated in the embodiments. That is, the invention may be used in any suitable variable valve device as long as the device includes a variable mechanism for varying valve timing and a fixing mechanism for fixing the valve timing at a middle angle. Also in this case, advantages similar to the advantages of the illustrated embodiments are ensured.

### DESCRIPTION OF THE REFERENCE NUMERALS

1 . . . Internal Combustion Engine, 10 . . . Engine Body, 11 . . . Cylinder Block, 12 . . . Cylinder Head, 13 . . . Oil Pan, 14 . . . Combustion Chamber, 15 . . . Crankshaft, 16 . . . Starter Motor, 17 . . . Alternator, 20 . . . Variable Valve Device, 21 . . . Intake Valve, 22 . . . Intake Camshaft, 23 . . . Exhaust Valve, 24 . . . Exhaust Camshaft, 30 . . . Variable Mechanism (Hydraulic Variable Valve Mechanism), 31 . . . Housing Rotor, 32 . . . Housing Body, 32A . . . Partition Wall, 33 . . . Sprocket, 34 . . . Cover, 35 . . . Vane Rotor, 36 . . . Vane, 37 . . . Accommodation Chamber, 38 . . . Advanced Angle Chamber, 39 . . . Retarded Angle Chamber, 4 . . . Fixing Mechanism, 40 . . . First Restricting Mechanism, 41 . . . First Restricting Pin, 41A . . . Pin Body Portion, 41B . . . Pin Distal End Portion, 42 . . . First Restricting Spring, 44 . . . First Restricting Chamber, 45 . . . First Spring Chamber, 46 . . . First Engagement Groove, 46A . . . First Advanced Angle End Portion, 46B . . . First Retarded Angle End Portion, 46C . . . First Stepped End Portion, 47 . . . First Lower Groove Portion, 48 . . . First Upper Groove Portion, 49 . . . First Stepped Portion, 50 . . . Second Restricting Mechanism, 51 . . . Second Restricting Pin, 51A . . . Pin Body Portion, 51B . . . Pin Distal End Portion, 52 . . . Second Restricting Spring, 54 . . . Second Restricting Chamber, 55 . . . Second Spring Chamber, 56 . . . Second Engagement Groove, 56A . . . Second Advanced Angle End Portion, 56B . . . Second Retarded Angle End Portion, 56C . . . Second Stepped End Portion, 57 . . . Second Lower Groove Portion, 58 . . . Second Upper Groove Portion, 59 . . . Second Stepped Portion, 60 . . . Lubricating Device, 61 . . . Oil Pump, 62 . . . Hydraulic Pressure Control Device, 63 . . . First Oil Control Valve, 64 . . . Second Oil Control Valve, 65 . . . Oil Control Valve, 70 . . . Lubricant Oil Passage, 71 . . . First Oil Supply Passage, 72 . . . First Oil Drainage Passage, 73 . . . Second Oil Supply Passage, 74 . . . Second Oil Drainage Passage, 75 . . . Advanced Angle Oil Passage, 76 . . . Retarded Angle Oil Passage, 77 . . . First Restricting Oil Passage, 78 . . . Second Restricting Oil Passage, 79A . . . Oil Supply Passage, 79B . . . Oil Drainage Passage, 81 . . . Battery, 82 . . . Auxiliary Electric Device, 90 . . . Control Device, 91 . . . Electronic Control Unit, 92 . . . Crank Position Sensor, 93 . . . Cam Position Sensor, 94 . . . Coolant Temperature Sensor, 95 . . . Voltage Sensor, 130 . . . Variable Mechanism.

1. A start control device for controlling a starting manner in an internal combustion engine having a hydraulic variable valve mechanism that varies valve timing and fixes the valve timing at a middle angle,
wherein, with the engine speed during cranking when the valve timing is not fixed at the middle angle defined as a first engine speed and the engine speed during cranking when the valve timing is fixed at the middle angle defined as a second engine speed, the start control device performs speed reduction control to decrease the first engine speed compared to the second engine speed during engine starting.

2. The start control device according to claim 1, wherein
the engine includes a motor that applies torque to a crankshaft, and
with the torque applied from the motor to the crankshaft when the valve timing is not fixed at the middle angle defined as a first torque and the torque applied from the motor to the crankshaft when the valve timing is fixed at the middle angle defined as a second torque, the speed reduction control decreases the first torque compared to the second torque during engine starting.

3. The start control device according to claim 1, wherein
the engine includes a motor that applies torque to a crankshaft, and
with load of the motor when the valve timing is not fixed at the middle angle defined as a first motor load and load of the motor when the valve timing is fixed at the middle angle defined as a second motor load, the speed reduction control increases the first motor load compared to the second motor load during engine starting.

4. The start control device according to claim 1, wherein the speed reduction control is carried out only when an engine temperature is lower than a predetermined temperature.

5. The start control device according to claim 2, wherein the speed reduction control is started after a predetermined time elapses from initiation of cranking.

6. The start control device according to claim 5, wherein the predetermined time corresponds to the period from when cranking is initiated to when an initial compression stroke is completed.

7. The start control device according to claim 5, wherein, when the voltage of a battery for supplying electric power to the motor is lower than a predetermined voltage, the speed reduction control is started after the predetermined time.

8. The start control device according to claim 1, wherein the speed reduction control is ended after a reference time elapses from initiation of the speed reduction control.

9. The start control device according to claim 1, wherein the hydraulic variable valve mechanism is configured to change a valve timing of an intake valve, the hydraulic variable valve mechanism including a restricting mechanism that restricts change of the valve timing in a retarding direction when the valve timing advances from an angle retarded with respect to the middle angle based on a cam torque change during engine starting.

10. The start control device according to claim 1, wherein the hydraulic variable valve mechanism is configured to change a valve timing of an exhaust valve, the hydraulic variable valve mechanism including a restricting mechanism that restricts change of the valve timing in an advancing direction when the valve timing retards from an angle advanced with respect to the middle angle based on a cam torque change during engine starting.

11. The start control device according to claim 3, wherein the speed reduction control is started after a predetermined time elapses from initiation of cranking.

12. The start control device according to claim 11, wherein the predetermined time corresponds to the period from when cranking is initiated to when an initial compression stroke is completed.

13. The start control device according to claim 11, wherein, when the voltage of a battery for supplying electric power to the motor is lower than a predetermined voltage, the speed reduction control is started after the predetermined time.

14. The start control device according to claim 1, wherein
the engine includes a motor that applies torque to a crankshaft, and
the speed reduction control reduces electric current supplied to the motor.

15. The start control device according to claim 14, wherein the speed reduction control reduces the electric current supplied to the motor by changing the operating state of an auxiliary electric device, which is provided in a vehicle having the internal combustion engine, from a deactivated state to an activated state or by increasing output of the auxiliary electric device in an activated state.
